(19) United States
(12) Patent Application Publication
(10) Pub. No.: US 2002/0062260 A1
(43) Pub. Date: May 23, 2002

(54) System for placing orders having mechanism for replacing an item in an electronic catalog

(76) Inventors: Makoto Inoue, Kanagawa (JP); Kimio Ariga, Saitama (JP); Tsuguharu Nishizaki, Kanagawa (JP); Nobuhiko Hasegawa, Chiba (JP); Katsumi Ueno, Kanagawa (JP); Junji Ushironaka, Hyogo (JP); Youichi Matsuura, Kyoto (JP); Masamichi Kine, Nara (JP); Jun Benki, Hyogo (JP); Masaru Sashiki, Tokyo (JP)

Correspondence Address: MCGINN & GIBB, PLLC, 8321 OLD COURTHOUSE ROAD, SUITE 200, VIENNA, VA, 22182-3817, US

(21) Appl. No.: 09/957,449

(22) Filed: Sep. 21, 2001

(30) Foreign Application Priority Data
Sep. 22, 2000 (JP) 288212/2000

(51) Int. Cl. G06F 17/60

(52) U.S. Cl. 705/26

(57) ABSTRACT

A system for executing and managing purchases of items at low cost is disclosed. This system comprises a database 9 which stores various kinds of masters and a server 10 connected to prescribed terminals 1 via a network such as the Internet. When items stored in a merchandise master are to be replaced with items that are replaceable and not contained in a customer specific electronic catalog (MD related information), the server controls the replacement of items provided from the dealers to the customers according to predefined automatic replace levels. Thus changes are made in items according to predetermined contract, and manufacturing suspensions and introduction of new products and the like can be coped with.

### BACKGROUND OF THE INVENTION

The present invention relates to an ordering system, especially an ordering system that controls sending/receiving orders between a customer to which many users belong and dealers who provide the users of the customer with goods, services, etc.

In organizations such as companies, many kinds and large amounts of MRO (Maintenance, Repair and Operations) such as stationery and tools and furniture are consumed. These consumable supplies are necessary for business management of the organization, purchases are controlled in relation to the budget and accounting.

Consumable supplies, tools, furniture, etc. are indirectly necessary for business activities and production activities and are known as non-production or subsidiary materials.

Purchases of non-production materials are made in small quantities, frequently, and in a wide variety, and the sellers who are dealers and their purchase condition are often different for each item and area. Therefore, purchase control by the organization is complicated. In large-scale organizations having hundreds of employees, a list of items to be purchased and their prices over a certain period are negotiated with dealers. In general, a person in charge of the company's purchase department negotiates with dealers. Organizations such as companies attempt to the reduce work load of controlling purchases by engaging in purchase activities over a certain period in accordance with the negotiated results.

On the other hand, the ordering and sale of goods and services have been done via the Internet in recent years. Namely, the providers of the goods construct Web sites, and those who wish to purchase these goods electronically visit various kinds of Web sites and select the goods to be purchased. Goods and services offered using Web sites include books, groceries, automobiles, stationery, computers, transportation services, and gift services such as live flowers, etc. Offerings of good and services using Web sites are similar to shopping malls and shopping centers in the real world. Namely, each purchaser performs searches on a Web site that deals with the goods to purchase, compares the contents of the goods, and subsequently orders one to the Web site. Then the payment for the goods or service is done using a credit card, bank transfer, etc. In many cases, each of the goods etc. is sent directly to the purchaser's address. Also, in the case of gift services such as live flowers and gifts, the gifts are often sent directly to the recipients.

Also, business to business platforms utilizing the Internet have been gradually realized. These are developed mainly for the procurement of material directly used in the business and production activities. In many platforms, the selection process of materials and dealers to order from based on pricing conditions etc. is supported.

In purchasing items at prices decided between the customer and dealer beforehand, in order to issue orders based on the agreed upon conditions, the customer must place an order with the dealers and make reference to the conditions agreed upon with each of one or more stores, requiring certain knowledge in relation to placing orders and making requests.

In the example, unfortunately, it is difficult for a user himself/herself who wishes to obtain the item to perform the ordering process himself. In this case, there needs to be an indirect business in charge of placing the order, upon receipt of the request from the user himself/herself, resulting in enormous personnel costs (business cost, transaction cost, or personnel expense). Especially, when the items are low in price and of many kinds, the total purchase price to the organization may be exceeded by the management costs necessary for the purchase. Also, in order for a user (e.g., an employee other than the purchase department of the company) to issue an order, the user himself/herself in the organization has to know the dealer. Keeping company employees informed of the individual dealers for each of the items also causes the personnel cost to increase.

Also, as to the management of purchase activities, such as budget control, the approval of items to be purchased, and accounting control related to purchases, if purchase conditions and purchase methods are unified in an organization, savings in the form of personnel cost reduction related to approval and accounting can be achieved. However, because the purchase of non-production materials is frequent and of many kinds, checking whether the enormous contents processed with handwritten slips conform with the organization's purchase regulations and agreements with the stores has been practically impossible.

Namely, in accomplishing purchases with handwritten slips, it is practically impossible to be thorough with a unified purchase condition and purchase method, and a huge personnel costs are incurred in trying to maintain a unified purchase method. On the other hand, because a unified purchase activity is difficult, the reduction of personnel costs also becomes difficult in managing purchases with accounting control. Especially, when there are trades with many dealers, this trend becomes significant.

Because purchasing activities and the management of non-production materials and subsidiary materials are indirect to regular business and production activities, although they should be performed at low cost, there has been the inconvenience that they require huge personnel costs in organizations cited in the earlier examples.

Because companies must create documents necessary to paying various kinds of taxes, and documents necessary for accounting reports, the purchases of non-production materials etc. and related accounting processing are indispensable for companies. The fact that the purchase management of non-production materials is an indispensable activity makes it difficult to reduce “invisible costs” related to the purchase of non-production materials. Namely, the purchase of non-production materials and related accounting processing cannot be eliminated.

Therefore, for the management of each company, an investigation of how to reduce costs related to the purchase of non-production materials becomes necessary.

Also, when taking advantage of the sale of items on a business-to-business platform or a Web site, a search must be made to find dealers that offer the required items. Also, because even a user who simply needs an item must solve the problem of at what price to purchase the item, each user must know the purchase conditions and method of purchase of the organization he or she belongs to.

Namely, from the standpoint of reduction of personnel costs in an organization, searching for stores that offer the item, comparing the prices, studying the purchase conditions etc. inside the organization, etc. are also considered as costs.

Conventionally, when an organization trades with many dealers, purchase-related personnel costs becomes large.

Then, in the case of a transaction based on a regular purchase agreement, the transaction item is often determined between the customer and the dealer periodically, such as once every year or every two years. During that period, various situations arise, such as the manufacture of an item of a supplier being suspended, and that item number going out of production, or a change in the customer's business necessitating the placement of an order for a different item, or the necessity of item transactions where goods or service particulars are determined while negotiating with dealers individually.

During the term of this regular purchase agreement, if the transaction items have to be renegotiated every time there is a change in the transaction items, such as an item going out of production or a new product proposed, it becomes impossible to reduce personnel costs.

### SUMMARY OF THE INVENTION

The object of the present invention is to offer an ordering system where inconveniences such as those cited in the conventional example are improved, and especially the purchase of a part of non-production materials or production materials can be executed and managed at low cost by immediately issuing an additional order when an item is consumed.

In the present invention, a database wherein are stored various types of master, and a server for controlling data communications with a plurality of terminals through a network and also extracting or storing data for the various types of master in response to requests from the terminals are comprised. The database comprises a merchandise master wherein is stored information relating to items such as goods or services provided to customers from suppliers through sales outlets or other dealers, by a unique item number assigned to each of those items, and a merchandise assortment (MD) related master wherein is stored a list of traded items, among those items stored in that merchandise master, for each purchase unit of the customer, for each dealer providing the items to that customer, which have been agreed upon beforehand between that customer and dealer, as MD related information.

A configuration is adopted wherein a server comprises an item replacing controller that, when performing replacement to an item (old item) stored in the merchandise master and an item that is both a replaceable item (new item) and an item not contained in the MD related information (new item), controls the replacement of items provided from the dealers to the customers in accordance with an automatic replace level defined beforehand in the MD related information. The intent is thereby to attain the object described earlier.

This order placing and receiving system is a system for controlling the placing and receiving of orders between customers (companies, for example) and dealers who provide items such as goods and services to those customers. The customers conduct transactions with a plurality of dealers, according to the types of goods and the geographical locations of the users of the customers. The transaction items correspond to various goods or various services.

In a preferable embodiment aspect, the dealers performing transactions are specified, the price can be automatically specified at the time the order is placed, and items are handled for which it is determined that, as far as a customer is concerned, the job of selecting between a plurality of dealers for the same item is not performed. The items in view here are goods or services, among such, for example, as stationery and other expendable items, furniture, fresh flower delivery services, rubber stamp production services, ticket purchases, and books, for which no price negotiations or selection of dealer according to conditions at the time of purchase are made. The items are goods or services, and to different items are applied different item numbers capable respectively of being distinguished. As a general rule, it will be better to handle primarily non-selected items for which sorting or selection or auctioning is not done at the time of purchase, or items for which the purchase conditions have been established based on a purchase agreement which is periodically updated, or the like. On an exceptional bases, items are handled for which the item content or price differs from one to another, such as cleaning services or moving services or the like (second and third embodiment aspects).

In a preferable embodiment aspect of the present invention, based on the merchandising of one or a plurality of dealers, merchandise assortment by dealer specified by the purchasing management division, for example, of a customer, is used as a customer specific electronic catalog. In this embodiment aspect, the customer specific electronic catalog is managed as MD related information. In this merchandise assortment/electronic catalog is stored information necessary for specifying the dealers or suppliers for each item. Alternatively, provision may be made so that an electronic catalog is used which is common to all customers. In that case, the merchandise master is used as an electronic catalog without using the MD related information.

The MD related information connects the customers and dealers (sales outlets). Accordingly, the customers select items from out of the merchandise assortments of the dealers and perform processing to place orders therefor. When that is being done, in a preferred embodiment aspect, provision should be made so that, when an item (or item number, in terms of the system) has been specified, a single dealer out of a plurality of dealers is selected. In this example, for the same goods or services, a periodic purchase agreement is concluded with a single dealer. In another embodiment aspect, when periodic purchase agreements have been made with a plurality of dealers for the same goods, a dealer is specified at the time the order is placed, without requiring human decision, according to the delivery date, price, and a predetermined order of priority. Thus, by making it possible to place orders, using the MD related information, without the user placing the order requiring prior knowledge of the relationships between the various goods and the various dealers, the personnel costs involved in purchasing can be reduced.

Various forms are conceivable for an order placing and receiving system which uses MD related information, but the basis thereof is a periodic purchase agreement relating to a specific item handled. The periodic purchase agreement is an agreement made between a customer and a dealer (with other players who support the sales activities of the dealer sometimes involved too) concerning purchases, wherein are determined the items that can be provided, price determining schemes and prices, and delivery modes and the like. The MD related information is defined with this customer (or with purchasing units such as individual users or divisions belonged to of the customer) and dealer as keys. In the MD related information master, this plurality of sets of MD related information is stored.

With the present invention, authorization is sought for the handling of items not in a predetermined merchandise assortment, in an order placing and receiving system that connects customers and dealers with merchandise assortment information, reflecting such a periodic purchase agreement.

The item replacing controller controls replacements from old goods to new goods, or from an item of one supplier to an item of the same or another supplier having a similar function. In such item replacement, in cases such as where an item of some supplier goes out of production, the automatic switching to another item sometimes accords with the desires of the customer. When there has been a proposal for a switch to a new product, or the like, there are cases where it is desirable that that be done electronically between the customer and the dealer, or the like, or by direct consultation. Meanwhile, there are also cases where a purchasing management handler of a customer, who handles periodic purchase agreements, will perform work related to such purchasing only during times when making periodic purchase agreements, and at other times will find it difficult to find time for doing work relating to purchasing. In such cases as that, even when the replacement of an item number is made from a supplier or the like, it is desirable that a decision be made automatically to implement or not implement that replacement without making any response whatever. This item replacement function can also be used for dealer item supplier changeover management or the like.

With the present invention, the item replacing controller, when performing replacement to an item stored in the merchandise master and an item that is both a replaceable item and an item not contained in the MD related information, controls the replacement of items provided from the dealers to the customers in accordance with an automatic replace level defined beforehand in the MD related information. That is, it is assumed that such things as whether or not to perform an item replacement automatically, under what kind of conditions automatic replacement is to be performed, and to automatically decide not to perform an item replacement under certain conditions, and the like, are determined when MD related information is prepared between a customer and a dealer. It thereby becomes possible to predetermine, when concluding a periodic purchase agreement, what responses are to be taken to changes thereafter, and to seek to reduce personnel costs from a long-range perspective.

In a preferred embodiment aspect, that automatic replace level is determined for every set of MD related information. Thus, while being able to automatically implement item replacement under certain conditions, it is possible, on the other hand, using the pre-determined automatic replace level, to decide to implement processing relating to goods of a supplier, for example, such as determining a price from a dealer to a customer. It is also possible to decide automatically not to implement item replacement under other conditions. The processing for storing item number replacements is described in detail in conjunction with the first embodiment aspect. In the first embodiment aspect, there is also disclosure of processing for performing replacements at the time an order is placed and received, based on information relating to transfers stored.

With the second embodiment aspect, conversely, a procedure (free form order placement) is disclosed for a customer, at his or her end, to place an order for an item not in a merchandise assortment. And in the third embodiment aspect, disclosure is made of the correlations between the MD related information, item replacements that are dynamic changes therein, and the free form, focusing on the part that functions as an application service provider toward a dealer.

In a preferred embodiment aspect, moreover, with respect to the distribution of items, commercial channels and physical logistics are separated. That is, while a dealer effects a sale by transferring the ownership of an item to a customer, the actual item can be sent directly to the user of that customer from the supplier or deliverer thereof. Thus it is possible to perform the transfer of ownership in an item from the supplier to a customer via an intermediate distributor of dealer (commercial channel) without involving the physical distribution of the item (physical logistics). In that case, the dealer, by concluding a periodic purchase agreement with the customer, effects sales during that period without holding inventory or making deliveries. By using a deliverer, on the other hand, more efficient physical logistics for a plurality of users can be realized, and, furthermore, by making the entity that is to hold the inventory a supplier, inventory management can be conducted more advantageously.

With the system of the present invention, moreover, when there is no item replacement, price negotiations are not performed for every order made between the customer and the dealer (they having agreed beforehand for a certain time period). Even when an item replacement comes up, moreover, if conditions determined beforehand by agreement are met, the item is replaced without price negotiations having to be conducted. Accordingly, it is possible to make prior determinations on prices by a distribution channel other than that between the customer and dealer. When an item is determined on, the supplier is also determined, wherefore the deliverer for each item can be automatically specified. By these means, the present invention as based on this embodiment aspect, as a distribution facilitating system, upon receiving an order from the user of a customer, can specify a predetermined commercial channel, and separately control the delivery of that item from a deliverer to the user of the customer.

### BRIEF DESCRIPTION OF THE DRAWINGS

FIG. 1 is a block diagram representing the configuration of one embodiment aspect of the present invention;

FIG. 2 is a block diagram representing an example of a detailed configuration for the item replacing controller indicated in FIG. 1;

FIG. 3 is an explanatory diagram representing the relationships with customer purchasing units (user groups) of MD related information used in the configuration diagrammed in FIG. 1;

FIG. 4 is a flowchart for one example of order placing and receiving processing in the configuration diagrammed in FIG. 1;

FIG. 5 is a flowchart for an example of item replacement control processing in the configuration diagrammed in FIG. 1;

FIG. 6 is a block diagram representing an example configuration of an embodiment in a first embodiment aspect;

FIG. 7 is an explanatory diagram representing the relationships between the users in the merchandise assortment units in this embodiment;

FIG. 8 is an explanatory diagram representing the relationship between item numbers and users in the merchandise assortments diagrammed in FIG. 6;

FIG. 9 is a block diagram representing one example of a configuration relating to item replacement in this embodiment;

FIG. 10 is a chart representing the relationship between automatic replace levels and price differences and the like;

FIG. 11 is an explanatory diagram representing examples of typical data items in the masters in this embodiment, with FIG. 11(A) being a diagram representing example data items in a merchandise master, FIG. 11(B) a diagram representing example data items in a merchandise assortment unit master, and FIG. 11(C) a diagram representing example data items in a merchandise assortment master;

FIG. 12 is an explanatory diagram representing examples of typical data items in the masters in this embodiment, with FIG. 12(A) being a diagram representing example data items in an item replacement master, and FIG. 12(B) a diagram representing example data items in an item replacement judgment master;

FIG. 13 is an explanatory diagram representing examples of typical data items in the masters in this embodiment, with FIG. 13(A) being a diagram representing example data items in a user/merchandise assortment unit master, FIG. 13(B) a diagram representing example data items in a customer/dealer correspondence master, and FIG. 13(C) a diagram representing example data items in a commercial channel management master;

FIG. 14 is an explanatory diagram representing examples of typical data items in the masters in this embodiment, with FIG. 14(A) being a diagram representing example data items in a customer master, and FIG. 14(B) a diagram representing example data items in a user master;

FIG. 15 is a block diagram representing an example configuration of a second embodiment aspect of the present invention; and

FIG. 16 is a block diagram representing an example configuration of a third embodiment aspect of the present invention.

### DESCRIPTION OF THE PREFERRED EMBODIMENTS

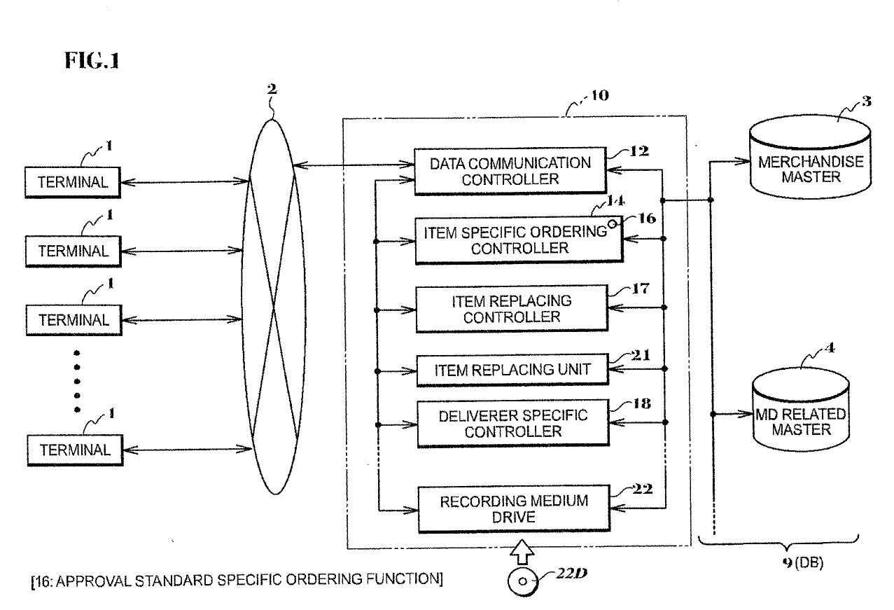

One embodiment aspect of the present invention is now described with reference to the drawings. FIG. 1 is a block diagram representing the configuration of one embodiment aspect of the present invention. The order placing and receiving system according to this embodiment comprises a database (DB) 9 wherein various kinds of master are stored, and a server 10 connected to a prescribed terminal 1 through a network 2 such as the Internet. The server 10 controls the sending and receiving of data with the terminal 1 and extracts and/or stores data from and to various kinds of master in response to requests from terminals. More specifically, the server 10 comprises a data communication controller 12 for controlling the sending and receiving of data with a plurality of terminals 1, and extracts and/or stores data from and to various kinds of masters in response to requests from the terminals. In the example diagrammed in FIG. 1, a database server comprises the functions of an item specific ordering controller 14 and an item replacing controller 17 and the like. When the Internet is used as the network, the data communication controller 12 is a web server that communicates with terminal browsers according to the HTTP protocol.

With a configuration based on this embodiment aspect, the placing and receiving of orders between a plurality of customers (customer administrative units) and a plurality of dealers can be conducted with a single server. The dealers are, for example, sales outlets for expendable stationery supplies, sales outlets for office furniture, and sales outlets for scientific instruments. The customers in view are organizations such as companies having a general affairs department for making purchasing related decisions and an operations department engaged in business operations, or the like, with a number of users equal at least to a certain level.

In the example diagrammed in FIG. 1, the database 9 comprises a merchandise master 3 wherein is stored information related to items provided to customers from dealers by unique item numbers assigned to those items, and an MD related master 4 wherein is stored MD related information that is a list of items handled and for which orders are placed and received between a customer and dealer, predetermined for each purchasing unit of that customer and for each dealer providing items to that customer, among the items stored in that merchandise master. The items for which orders are placed and received include goods such as indirect materials or subsidiary materials, and various kinds of services. When the term item for which an order is placed and received is used, that means an item for which a customer (user belonging to a purchasing unit of a customer) places an order with a dealer, and for which the dealer receives an order from the customer. The predetermined items are generally determined by trade talks between a dealer and a customer's purchasing management person in charge.

The merchandise master 3 may also be made so that, in addition to the merchandise data managed internally in the order placing and receiving system, it stores information relating to merchandise data managed at a web site of a cooperating supplier or the like. Or, more preferably, information relating to items managed on another site may be obtained by cooperative processing for each order placed. When a periodic purchase agreement for hanging an item not stored in the merchandise master is concluded in consultation between a customer and dealer, the new item is first stored in the merchandise master, prior to preparing the merchandise assortment. In this embodiment aspect, even in a case where the same product is handled by a plurality of dealers, descriptive images of that product or information relating to the supplier or the like is managed with the single merchandise master 3. For that reason, there is no need for dealers to store information or perform maintenance relating to individual items themselves.

In this embodiment aspect, the server 10 comprises the item specific ordering controller 14 which, when an order placement request for placing an order for one or a plurality of items is received from a terminal used by a user belonging to a purchasing unit, specifies the dealer or dealers providing those items in that order placement request, based on MD related information for each purchasing unit to which that user belongs. The purchasing unit is a user group which makes purchases from the same dealer under roughly the same conditions according to the department or division, the geographical location, or the authority held by that user, or the like. Depending on the customer's purchasing form, there will be cases where the purchasing units are made individual users, and cases where the purchasing units will be divisional groups specific to geographical locations.

The item specific ordering controller 14 specifies a single set of MD related information based on the purchasing unit to which the user belongs and the item number of the item selected. When the MD related information has been specified, the dealer that will provide that selected item to that user can be specified. In the MD related information, the price specifying scheme for the selected item, and other attributes relating to the distribution of that item, such as the supplier or deliverer or the like for that item, should preferably be defined ahead of time, whereupon, when an order is placed from a user, the details of the order placed and received can be specified based on the attribute information relating to the distribution of that item.

This MD related information is studied between a customer and a dealer (or supplier or sales facilitator or other sales activity entity) at the time the periodic purchase agreement is concluded, and generated. In general, a periodic purchase agreement is renewed periodically, such as once every year or once every plural number of years, the periodic purchase agreement is concluded, and transactions are conducted according to the content of that agreement, and thereby a customer is able to reduce the work load related to purchasing.

Transactions according to such periodic purchase agreements as this can be effectively systematized using MD related information. However, it sometimes happens that the manufacture of an item among the items being handled (merchandise assortment) will be suspended by a supplier prior to the renewal of that agreement. There are also times when a request is tendered by a supplier expressing a wish that an old product be replaced by a new product by the new product being supplied from the supplier. Take the case where, for example, a manufacturer develops a product that can be recycled in a field where an environmentally compatible product previously did not exist. It is possible to suppose a case where a dealer makes a proposal to the customer, asking whether it would not be better to change an item being handled to a recyclable item in keeping with the environmental policies of that customer.

If the replacement of these items can be performed advantageously, a user belonging to a purchasing unit of a customer can purchase new products, goods having specific functions can be effectively prevented from running out, and goods responsive to various demands can be made items included in merchandise assortments. However, customers concluding periodic purchase agreements generally go ahead and determine nearly all purchasing-related conditions when concluding that agreement, and there are cases where, in the subsequent course of carrying on business, work time relating to purchasing is cut back.

With this embodiment aspect, at the time of concluding a periodic purchase agreement (when generating and storing MD related information), rules concerning item replacement are established. Then, when a proposal to change an item is actually made, processing is automatically implemented according to the conditions, inclusive of deciding whether or not to implement the item replacement. With this embodiment aspect, as diagrammed in FIG. 1, the server 10 comprises an item replacing controller 17. This item replacing controller, when performing a replacement of an item stored in the merchandise master noted earlier to by item that is a replaceable item and one not contained in the MD related information noted earlier, controls the replacement of an item provided from the dealers to the customers according to the automatic replace level predefined in the MD related information.

The item replacing controller 17, when the replacement of an item (item replacement) has been proposed by a supplier or a dealer or other sales activity entity, controls the replacement of the item in accordance with the automatic replace level predefined at a time such as when the MD related information based on a periodic purchase agreement was generated. When the price of the old item is the same as the price of the new item, for example, a decision to implement the item replacement may be made. When there is a difference in price, a decision may be made as to whether or not to implement an item replacement based on that price difference and the predetermined automatic replace level. Control may also be made so that a request is made to a dealer for some input or storing needed for the replacement.

The item replacement control functions of the item replacing controller 17 first respond to an item being out of production or a proposal for a new product. These item replacement control functions can also be used in the management of item suppliers by a dealer. There are cases, for example, where, having the same functions, for an item for which there is no awareness relating to item selection on the customer user end (such as a paper cup for a tea dispenser), or an item for which the supplier is changed according to the season, the dealer switches that supplier for a certain period of time. In such cases as that, provision may be made so that the item number of the item is made a different number for each supplier, and the switching of suppliers is executed as an item replacement. If the prices of the old and new items are the same, for example, for a customer for which an automatic replace level at which an item replacement is automatically implemented has been determined, the dealer can implement this supplier change automatically by using the item replacement function described above.

Thus the item replacing controller 17, based on a predetermined automatic replace level, after a periodic purchase agreement has been concluded, can automatically decide whether to implement or not implement an item replacement, without requiring any decision at all by a person in charge in a purchasing management division of the customer, even when an item is put out of production by a supplier or a proposal is made for the replacement of an item from any of various sales activity entities prior to the scheduled time for concluding the next periodic purchase agreement. When the price difference is large, moreover, control can be effected for considering whether or not to implement the item replacement through a dealer. That is, by predetermining the item replacement implementation scheme, the time spent by a person in charge in a purchasing management division can be further shortened.

When the conditions under which item replacement is automatically performed (conditions based on automatic replace level) have been determined by the purchasing management division of a customer, for example, if the item replacement proposal satisfies those conditions, there is no need for the person in charge in the purchasing management division of the customer to use any time at all in making a decision at the time the proposal is made. On the other hand, when the conditions under which an item replacement is to be automatically performed have been determined by the purchasing management division of the customer, in cases where the item replacement does not satisfy those conditions, a decision can be made automatically to execute the transaction with the old item irrespective of any proposal of the supplier.

Therefore, based on this embodiment aspect, the need for a person in charge in a purchasing management division to make individual responses to individual new product proposals disappears. Also, when the item replacement is contained in conditions for considering individually whether or not to implement the item replacement, if a setting is made so that the item replacement is implemented in cases where the price of the new item has been input by the dealer, for example, the dealer requests a consultation with the customer to discuss that item replacement, and considers whether to implement or not implement the item replacement. Thus, in order to decide to implement or not implement an item replacement based on an automatic replace level, and decide the necessity of a price or the like being input by the dealer, by making various studies at the time of concluding the periodic purchase agreement, the work time relating to subsequent item replacements can be minimized, while the users of the customer, on the other hand, can successively obtain new products in keeping with the purchasing conditions of that customer, and in keeping with the intentions of the purchasing management division.

In the example diagrammed in FIG. 1, the server 10 comprises an item replacing unit 21 that, when an item for which a new item number is defined in the MD related information in response to the control of the item replacing controller 17 is ordered from a terminal used by a user belonging to the purchasing unit noted earlier, sets the item replaced in that new item number as the object of order placement. The replacement of an item (item replacement) involves first a proposal being made from a supplier or dealer or the like to change from a current item to a new item, after which a determination is made as to whether or not to implement the item replacement, and, when the item replacement is to be performed, storing information relating to that item replacement in the MD related information or the like. This item replacing controller 17 is mainly a function relating to determining whether or not to implement an item replacement. When that item replacement has been stored, in cases where the order has been placed with the old item number, the item replacing unit 21 effects control so that this is handled as an order made with the new item number.

Let it be assumed that, when a periodic purchase agreement is concluded, the conditions under which an item replacement is automatically to be implemented are determined by the purchasing management division of the customer. Those conditions are stored in the MD related information as an automatic replace level. Then, when an item replacement that satisfies those conditions is proposed, in cases where a new product has been proposed from a supplier, for example, the storage of the item replacement from the old product to the new product is performed automatically in accordance with the automatic replace level. Then, when a user selects the old product item and places an order, that is handled as the placement of an order for the new product. In other words, there is no need to notify all the users belonging to a purchasing unit that that replacement is to be made. Thus the inability to obtain necessary items due to items going out of production disappears. Meanwhile, a person in charge in the purchasing management division of a customer can effect a switch automatically to a new product without making sure that all the users of that customer know about the switch to the new product. Also, in cases where many sets of MD related information (customer specific electronic catalogs) are stored for many customers, by the functions of this item replacing controller 17, even when production of an item is suspended, there is no longer any need to change all of the many sets of MD related information manually.

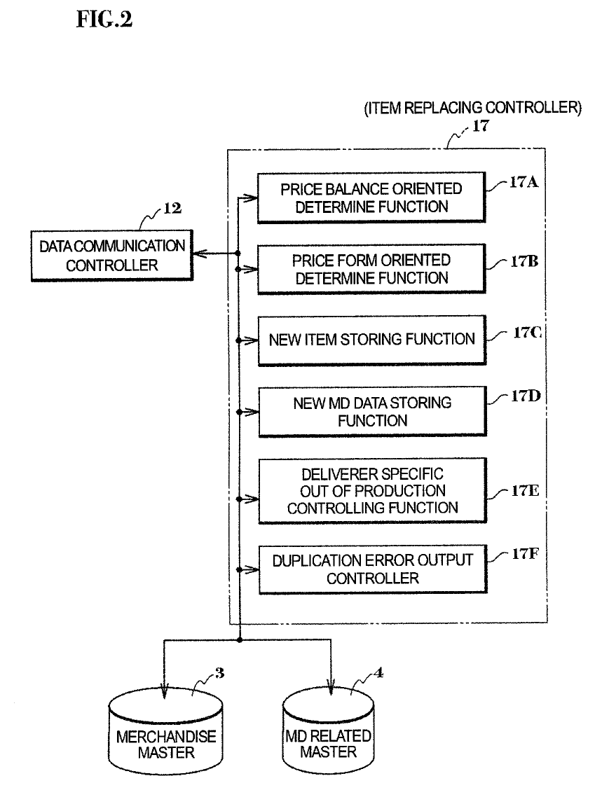

FIG. 2 is a block diagram representing an example of a detailed configuration for the item replacing controller indicated 17 diagrammed in FIG. 1. In the example diagrammed in FIG. 2, a configuration wherein a plurality of functions is integrally comprised is represented, but provision may also be made so that only one or a plurality of the functions represented in FIG. 2 is comprised.

In the example diagrammed in FIG. 2, the item replacing controller 17 comprises a price balance oriented determine function 17A. This function 17A determines whether or not to automatically implement a replacement to the various sets of MD related information in response to the difference between the price of that old item and the price of the new item (zero and positive or negative) and the automatic replace level. The “price of an item” is the price at which the item is sold by a dealer to a customer. The price balance oriented determine function 17A determines whether or not to automatically implement the replacement based on the price difference between the old item and the new item. In this example, for the automatic replace level in this example, an automatic replace level responsive to the price difference may be determined such that, for example, the item replacement is implemented when the item replacement results in a fall in price but is not implemented when the item replacement results in a rise in price.

Provision may also be made so that no automatic implementation is done when the price difference is at or higher than a certain value. Provision may also be made so that a determination as to whether or not to automatically implement item replacement is made based on the purchase performance (total purchase quantity) of the old item in the one month period prior to the proposal of the item replacement, and based on the difference between the total purchase monetary amount of that item when item replacement is not done and the total purchase monetary amount when it is assumed that the replacement was made.

In the example diagrammed in FIG. 2, the item replacing controller 17 comprises a price form oriented determine function 17B. This function 17B determines whether or not to automatically implement the replacement to the sets of MD related information according to the difference of whether the scheme for specifying prices of items from the dealer to a customer is a price determination based on a rate deliberated on for an item group or is a deliberated value placed on individual items, and the value of the automatic replace level. The MD related information is a list of items handled that is agreed upon between a customer and a dealer, the details whereof are studied in consultation between the customer (generally a person in charge in a purchasing management division in the general affairs department of a company) and dealer. In a preferable embodiment aspect, the supplier or dealer for items is determined item by item in the MD related information, and, when an order is placed for an item from a user belonging in a purchasing unit of the customer, the arrangements to have that item delivered to the customer may be automated. The MD related information is information for connecting the purchasing units of customers with dealers, and detailed information on items may be stored by item number in the merchandise master 3.

In this MD related information is stored, for each item, the price from the dealer to the customer or the price determining procedure. Provision may be made so that for comparatively expensive office furniture, for example, the actual price (actual amount) is determined for each item, while, for paper and the like, on the other hand, a rate is determined for application across the board of a rate applied to the manufacturer's suggested retail price or to the dealer purchase price (such as 100% if for set price sales or 90% if discounted 10%). The manufacturer's suggested retail price is a retail price desired by the manufacturer of that item. When the price is defined by a rate, there is no need to set individual prices on all of the items handled beforehand, wherefore the jobs of generating and storing the MD related information are made easy.

The price presented to a customer from a dealer, when that is set by actual amount, indicates that prices were studied separately, and it can be assumed that it was concluded that there is no need to raise or lower the actual amount for individual items. Accordingly, when it comes to item replacement also, inmost cases, a customer will deem it necessary to study the actual amount, even when it comes to item replacement, for items for which actual amounts are set, but, when prices have been set by a rate, will desire to trade at that rate, even when it comes to item replacement.

The price form oriented determine function 17B determines whether or not to automatically implement item replacement according as to whether or not the price determining scheme is a rate. That is, when it is necessary to set an actual amount for a new item, it is necessary to consider the price between the dealer and the customer, wherefore item replacement is not implemented automatically. In an example having this price form oriented determine function 17B, for the automatic replace level, in the case of a rate, the price is calculated according to the rate and the item replacement is implemented automatically, whereas, in the case of an actual amount, it will be well to determine a level at which, for example, it will be necessary for the dealer to store a price in order to implement item replacement. Provision may also be made so that, combining a price scheme with a price, the item replacement is implemented automatically in the case of a rate, but, in the case of an actual amount, the item replacement is not implemented if the item replacement results in the price rising, but is automatically implemented if it results in the same amount or a drop in price.

In the example diagrammed in FIG. 2, the item replacing controller 17 comprises a new item storing function 17C and a new MD data storing function 17D. Function 17C, in response to a proposal to a customer to adopt a new product or the like made to a customer by a sales activity entity such as a supplier or dealer or the like that provides an item to a customer, when an item number replacement has been designated by that customer, stores the old item number designated by that customer in the old merchandise assortment data in the MD related information used between that customer and the dealer. That is, with the old item, for the item number of an item that will not be subject to order subsequently, the item number of the new item is stored. Then, the function 17D stores new merchandise assortment data for the new item number stored by this function 17C.

With the item replacing unit 21 indicated in FIG. 1, when a valid new item number has been stored in the merchandise assortment data by the item replacing controller 17, the item number for which the order was placed is changed to the new item number, and a display is made to the user to the effect that the order was placed with the new item number. The item specific ordering controller 14, when an order is placed with this new item number, references the merchandise assortment data for the new item stored by the new MD data storing function 17D, and controls the placing and receiving of orders for that new item.

Next, a detailed description is given of the role played by the MD related information in this embodiment aspect, and, following that, the control of items going out of production and item replacement by updating this MD related information and the like are explained.

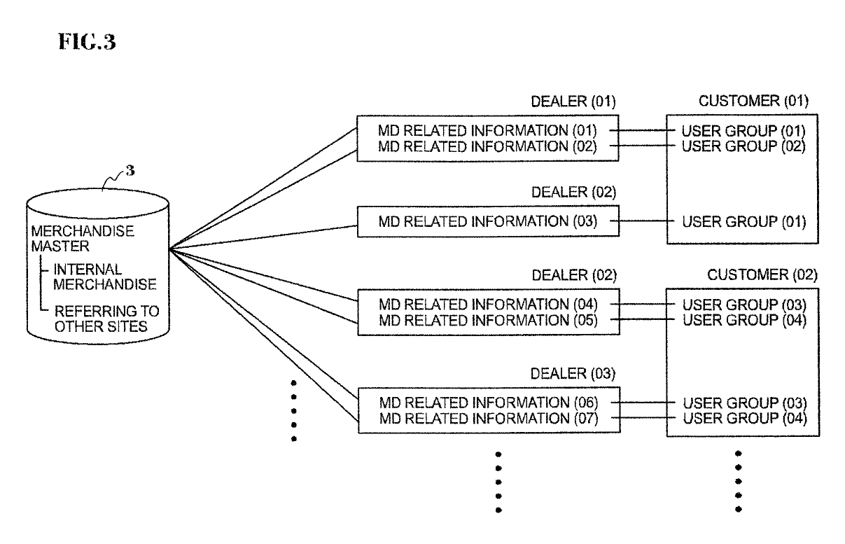

As shown in FIG. 3, a group of users of a customer (purchasing unit) and dealers are connected by MD related information, and items contained in the MD of the MD related information are items stored in the merchandise master 3. By using a merchandise master and MD related information stored separately for each group of users and dealers, storing and updating of information for each item are to be done only once in the merchandise master.

In the example shown in FIG. 3, a dealer (01) has two pieces MD related information (01 and 02) separate for each group of users to a customer (01). A dealer (02) has one piece of MD related information (03) for the customer (01). A group of users (01) of the customer (01) can make purchases by ordering items assorted in the MD related information (01) of the dealer (01) and items assorted in the MD related information (03) of the dealer (02). In the two pieces of MD related information (01 and 03) to the same group of users (01), it would be better to define the MD related information so that the same item is not duplicated.

If there is no duplication of items in a plurality of MDs to the same group of users, when a user specifies an item, a dealer who has the MD of the item can be specified uniquely. In the present embodiment, by configuring it so that, when this group of users and an item are specified, a dealer can be automatically specified, the specifications of the party for ordering each item and commerce channeling are performed.

When, for example, a user belonging to a purchasing unit of a customer logs into the order placing and receiving system based on this embodiment aspect, and specifies an item which he or she wishes to purchase, the MD related information is stored so that there is no duplication of the same item between dealers for the same user, wherefore, from this user and item, the MD related information can be specified as a unique entity. That being so, once the user and item have been determined, the dealer can be specified as a unique entity. For that reason, the user need only specify the item, and need not select a dealer. Thereupon, the user can place orders without prior knowledge of the names of dealers determined beforehand by the purchasing management division of that customer, or of the relationships between items and dealers.

Thus, with this embodiment aspect, unlike with commercial platforms or ordinary web sites, no specification of retail outlet (dealer) is made based on price comparisons or condition comparisons every time an order is placed. With this embodiment aspect, by using the MD related information, a dealer can be specified automatically and compulsorily when an order is placed, following a predetermined agreement. Thus the users in an organization such as a company can place orders directly using an immediately available terminal (such as a computer loaded with browser software for displaying pages written in a mark-up language such as HTML, for example), in accordance with suppliers, purchasing conditions, and purchasing methods and the like determined beforehand by the purchasing management division in that organization. When a user can place an order for an item directly, it is possible for needed portions to be ordered according to necessity, and inventory levels in the division in charge of purchasing or the like can be reduced. Not only can costs be reduced by reductions in these unit purchase prices and inventory, but the direct and indirect personnel costs required for purchasing management can also be reduced. There are cases, for example, where, when the total annual purchase amount for expendable items in an organization is “100,” the personnel costs for the personnel managing that “100” is “300.” Nevertheless, expendable items are absolutely necessary to carry on work, and therefore they must be distributed. There are also such mandatory tasks as making tax related reports and accounting procedures, wherefore reducing that “300” cost (invisible costs) has not been easy.

However, when item specific orders are placed using the MD related information, the work of the purchasing management division becomes that of determining the merchandise assortment with each dealer once every few years, and the actual order placements can be made directly by the users. Not only so, but those orders are placed with dealers at prices determined by the purchasing management division. In other words, merely by the users specifying the items, purchasing operations that follow purchasing conditions determined beforehand by the purchasing management division can be implemented directly by the users of the customer. And, particularly with this embodiment aspect, even when there is an item replacement, this MD related information is automatically renewed according to certain conditions, and switches are made automatically from old item order placement to new item order placement, wherefore, again, merely by the users specifying the items, new products and the like can be procured following an item replacement scheme determined beforehand by the purchasing management division.

In order for the MD related information to fulfill the role of specifying a dealer from the user and item, when a plurality of dealers handle the same item for the same user, processing to specify the dealer becomes necessary at order placement time. It will be well, with some embodiment, to adopt a configuration that, when there is a dealer redundancy, automatically specifies a dealer based on prescribed conditions. In order to simplify the system, it will be well to store MD related information so that the same item is not provided by a plurality of dealers to the same purchasing unit of a customer. That is, it is preferable that, in the MD related master 4, item numbers purchased by a purchasing unit of the customer are stored in a conditions such that there is no duplication for each dealer. It will be well for the server 10, for example, when MD related information is being stored in accordance with a periodic purchase agreement, to verify whether or not the items contained in the merchandise assortment in that MD related information are duplicated by a merchandise assortment in another set of MD related information stored for the customer purchasing unit for that first mentioned set of MD related information, and, when there is a redundancy in merchandise assortments for the same user between dealers, to output an error.

For item replacements, it will be well to verify whether or not there is a merchandise assortment redundancy between dealers for the same customer purchasing unit In this example, as diagrammed in FIG. 2, the item replacing controller 17 comprises a duplication error outputting function 17F that, when the new item number is stored in the MD related information by the new item storing function 17C, outputs a duplication error if there is a redundancy of dealers for the same customer for that item number. With this duplication error outputting function 17F, dealer redundancies for the same customer purchasing unit can be eliminated, and, thereby, item specific order placement can be stably effected using MD related information.

In the example shown in FIG. 3, the dealer (02) also has trades with a customer (02). At this time, even if the MD for the customer (01)'s group of users (01) and the MD for the customer (02)'s group of users (03) are the same, different pieces of MD related information are stored. By making such a configuration, the information on distribution of each item can be stored in the MD related information according to the relationship between the customer and the dealer. For example, even if MD (a list of items) is identical between the MD related information (03) and (04), when offered prices to the customer (01) and the customer (02) are different, and even when deliverers who deliver the items are different, by defining the attribute information on distribution defined for each item in the MD related information (03) and the attribute information on distribution in the MD related information (04) respectively, the purchase, sales, and delivery arrangement can be automated.

As a simplification for systematizing a complicated distribution network, it is good to adopt a mechanism where each item is delivered to the customer by the deliverer in the dealer's name. If the dealer has a stock and make deliveries to its customers, the dealer himself is stored as the deliverer.

In the example shown in FIG. 1, the server 10 comprise a deliverer specific controller 18 which, when an order request for ordering one or more items is received from a terminal used by a user who belongs to a purchasing unit, specifies a deliverer offering or delivering the goods or service for each item number by referring to the MD related information specific to the purchasing unit, and a function that outputs to the terminal 1 used by the deliverer the dealer data for delivery from the deliverer specified by the deliverer specific controller 18 in the name of the dealer specified by the item specific ordering controller 14.

In cases where the dealer holds inventory and delivers items to customers, that dealer itself becomes the deliverer. When a supplier operates business entities for making region specific deliveries, the delivery entities become deliverers according to region. A deliverer specifying controller 18 refers to MD related information by customer purchasing unit (user group), and specifies a deliverer to provide or deliver goods or services by item number. In this example, a deliverer for delivering a given item is defined beforehand in the MD related information, for each customer-dealer relationship, and for each item or item group (goods category).

Referring again to FIG. 2, the item replacing controller 17 comprises a deliverer specific out of production controlling function 17E. This function 17E first, when an item has been taken out of production by the supplier of the old item, refers to the MD related information and specifies the deliverer for delivering that item that is to be taken out of production to the customer. The function 17E, when that deliverer is not a dealer, logically deletes that item from the MD related information. When that deliverer is a dealer, on the other hand, the function 17E prompts the users of that dealer to reflect that item going out of production in the MD related information.

When production is suspended by a supplier, that item is taken out of production and can no longer be provided to customers. There are cases, meanwhile, where, even though an item has gone out of production, some deliverer will be holding some inventory. In particular, there are cases where some dealer will hold a lot of inventory of an item specified in a relationship with a customer. In such cases as that, that item that is to be taken out of production can be supplied to the customer until the inventory of that dealer is exhausted. Thus, when storing an out of production item in the MD related information, when the deliverer of that item is a dealer, the storing of the out of production item in the MD related information should be done in a time period that that dealer determines. For that reason, the deliverer specific out of production controlling function 17E references the deliverer and selects a scheme for storing the out of production item in the MD related information.

Also, in large-scale organizations, budget control and approvals are performed for each kind or use of non-production materials. In this example of performing budget control and approval control, an approval standard specific ordering controller 16 simplifies budget control etc. As the approval standard, whether an approval is performed or not, budget control, and the approval path in the group of approvers to perform an approval, etc. are defined. The item specific ordering controller 14 shown in FIG. 1 is equipped with an approval standard specific ordering control function 16 where, if the approval standard for ordering items by each customer is determined and one or more items are specified by users of the customer, and when the approval standards of the specified items and newly added items are different, addition of the new items is not accepted and a group ordering of those with the same approval standard is prompted.

The approval standard specific ordering control function 16 obtains approval standard related information such as an approval path, a person authorizing the budget, the upper limit amount requiring an approval, and a cumulative purchase amount over a certain period, such as a month, based on the budget or approval control unit (budget control unit) the user belongs to and the expense item for example. The expense item of each item is used for identifying the itemization unit such as account titles for accounting, classification of expenses of an individual organization, and the budget unit.

Budget and approval are controlled by each kind of goods or services, or the department to which the user belongs. Also, the purchase amount of an item for a project cannot be expended from a budget for another project. Conventionally, necessary items were ordered separately from each of many dealers and also by each budget unit separately. In the present embodiment, orders to a plurality of dealers can be made at one time specifically, each user can choose necessary items for ordering irrespective of the dealer, and hand them over to the approval process.

In this case, by the approval standard specific ordering control function 16, when an expense item is pre-determined for each item or input at the time of ordering, the maximum range that can be ordered at one time (namely, the unit of purchase data or billing data) is set to the range for same approval standard. Thus, it becomes unnecessary to obtain an approval for each divided purchase amount when items that belong to separate budget control units are ordered at one time. On the other hand, even if dealers or categories (ballpoint pens, electric bulbs, live flowers, etc.) are different, if they are in the same budget unit, they can be handed over to the approval process at one time.

In this way, in an embodiment having an approval standard specific ordering control function 16, ordering can be converted from conventional ordering by dealer to group ordering by budget control unit or approval unit, making it possible to perform approval at one time. Also, budget control and accounting control become easy, contributing to the reduction of invisible costs. In this example, in order to limit the maximum range of group orders by approval unit, purchases to be approved and purchases not requiring approval can be established according to the customer's actual situation and controlled automatically.

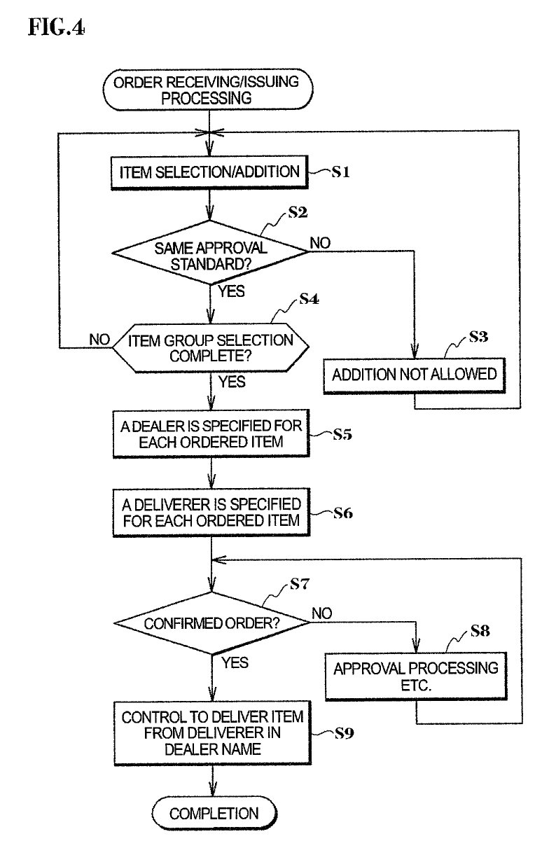

FIG. 4 is a flow chart showing an example of the order issuing/receiving processing in the configuration shown in FIG. 1.

As shown in FIG. 4, first, selection and addition of items are performed by a user (Step S1). At this time, the approval standard of already selected items and the approval standard of items added at this time are compared (Step S2), and when the approval standards are different, the addition to the group order is denied (Step S3). On the other hand, if they are identical approval standards, even if dealers of the items are different, they are added to the order item group. If the approval standards of items are different, their approval processes are different.

Because the approval standard specific ordering control function 16 (Step S2, S3, etc.) prompts the user to make them to be a different group of order items when they have different approval standards, items with different paths of approval process can be prevented from being ordered at one time. Namely, instead of ordering separately by each dealer, group ordering separated by each approval standard can be performed.

It may be better arranged so that each group of order items is temporarily stored using a shopping cart function commonly used, for example, on sales sites on the Internet.

Once selection of an item group is complete (Step S4), referring to the MD related information, a dealer is specified for each item subject to ordering (Step S5), and subsequently a deliverer of the item is specified (Step S6). Subsequently, when it has become a confirmed order (Step S7) in response to a formal order request or an approval by approvers (Step S8), a control for delivering item group from their respective deliverer in each corresponding dealer name is performed (Step S9). As to the commerce channels among the dealers, deliverers, and suppliers of each item, the item is automatically handed over from the supplier to the deliverer, and also systematization may be performed so that the sales/stock relationship from the supplier to the dealer is specified. Also, it may be arranged so that the dealer's stock is accumulated in the deliverer's storage.

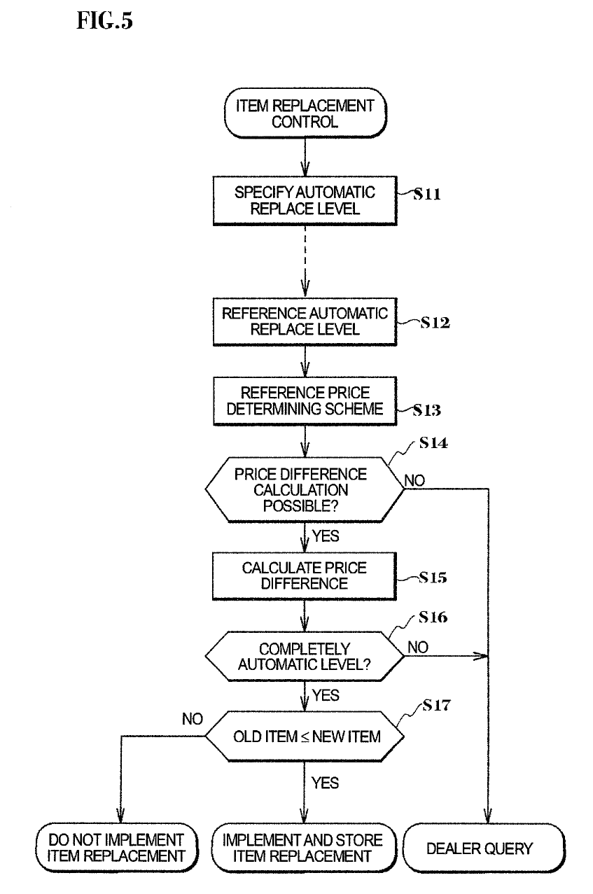

FIG. 5 is a flowchart for an example of item replacement control processing in the configuration diagrammed in FIG. 1 and FIG. 2. In the example diagrammed in FIG. 5, a processing example is described in a comparatively simple case where the automatic replace level is either “automatic” or something else. In the example diagrammed in FIG. 5, first, when storing MD related information, the replacement scheme when replacing an item among items handled and provided from a dealer to a customer with a new item is specified beforehand as an automatic replace level for each set of MD related information the unit whereof is a list of those items handled (automatic replacement level specifying process, step S11). After that, when a proposal for adopting a new product or the lik been made to the customer by a sales activity entity such as a sup or dealer or the like, the automatic replace level defined MD related information for that customer is referenced (aut replace level referencing process, step S12). Also, before or after that referencing process step S12, the MD related information is referenced and the scheme for determining the price of the old item is specified (price determining scheme specifying process, step S13).

Furthermore, based on the price determining scheme specified in this specifying process step S13, when the price of the new item can be calculated (step S14), the price difference between the price of that new item and the old item is calculated (price difference calculation process, step S15). Then, according to the combination of whether or not prices have been calculated in the price difference calculation process steps S14 and S15, and the difference in those prices when they have been calculated, a determination is made as to whether or not to implement the item replacement, or whether or not a query is made to the dealer (item replacement possible/not possible determining process). In the item replacement possible/not possible determining process, when the price could not be calculated in step S14, for example, in cases where the price is open, for example, a query is made to the dealer urging the price to be stored or the like. In the example diagrammed in FIG. 5, moreover, when the automatic replace level referenced in step S12 is “automatic level” (step S16), the price difference is calculated (step S17), and when the new item price is equal to or smaller than the old item price, that is, when it is the same amount or a lower price, the item replacement is implemented and automatically stored. When the price is higher, on the other hand, the item replacement is not implemented.

In step S16, when the automatic replace level is not “automatic level,” a query is made to the dealer concerning the implementation of the item replacement. The “query to the dealer” is one example of control to urge consideration between a customer and the dealer or the like. When in the item replacement possible/not possible determining process it is determined that the customer and dealer need to consider between themselves whether or not to implement the item replacement, a query is made to that dealer. When the consultation between the customer and dealer has been concluded, the price from customer to dealer for the new item is stored by the dealer. Alternatively, a scheme for determining the price at the judgment of the dealer may be effected in cases when it is not possible to automatically calculate the price, but the customer wishes nevertheless to implement item replacement automatically when the price falls, for example, due to an item replacement implementation level designation.

In the case diagrammed in FIG. 5, the description assumes two types of automatic replace level, namely “automatic level” and “everything else,” but this is one example, and automatic replace levels and their operation may be determined with various schemes between the customer and dealer. If things become complicated when building the system, the dealer may be queried concerning the portions difficult to systematize, and provision made so that whether or not to automatically implement an item replacement is determined by the dealer based on the periodic purchase agreement or the like with the customer. In a preferable embodiment, the automatic replace level is made three types, namely “verification scheme,” “automatic scheme,” and “intermediate scheme,” distinction is made further between two types, namely automatic scheme and intermediate scheme, for each price determining scheme, namely rate or actual amount or the like, and whether or not it is possible to implement item replacement and whether or not to query the dealer is determined for each price difference.

The configurations diagrammed in FIG. 2 and FIG. 1, and the processing example diagrammed in FIG. 5, can be effected by running programs (scripts) corresponding to the various functions on the server 10. An item replacement control program for causing a server-implementing computer to function as the server 10 in the order placing and receiving system according to this embodiment aspect comprises a plurality of commands which are commands for causing that server-implementing computer to operate. To begin with, this program comprises an automatic replace level specifying command for causing a replacement scheme used when replacing an item among the items handled and provided to a customer from a dealer with a new item to be specified, as an automatic replace level, in each set of MD related information for which a list of those items handled is made the unit. This automatic replace level specifying command is executed when generating MD related information.

This program further comprises: an automatic replace level referencing command for, when a proposal for the adoption of a new product or the like has been made to the customer by a sales activity entity such as a supplier or dealer or the like, causing the automatic replace level defined in the MD related information for that customer to be referenced; a price determining scheme specifying command for referencing the MD related information and causing the scheme for determining the old item price to be specified; a price difference calculating command for, when the price of the new item can be calculated on the basis of the price determining scheme specified in response to that price determining scheme specifying command, causing the price difference between the price of that new item and the old item to be calculated; and an item replacement possible/not possible determining command for causing whether or not to implement the item replacement or whether or not a query to the dealer is to be made to be determined, according to the combination of whether or not a price has been calculated in response to that price difference calculating command, that price difference when it is calculated, and the automatic replace level.

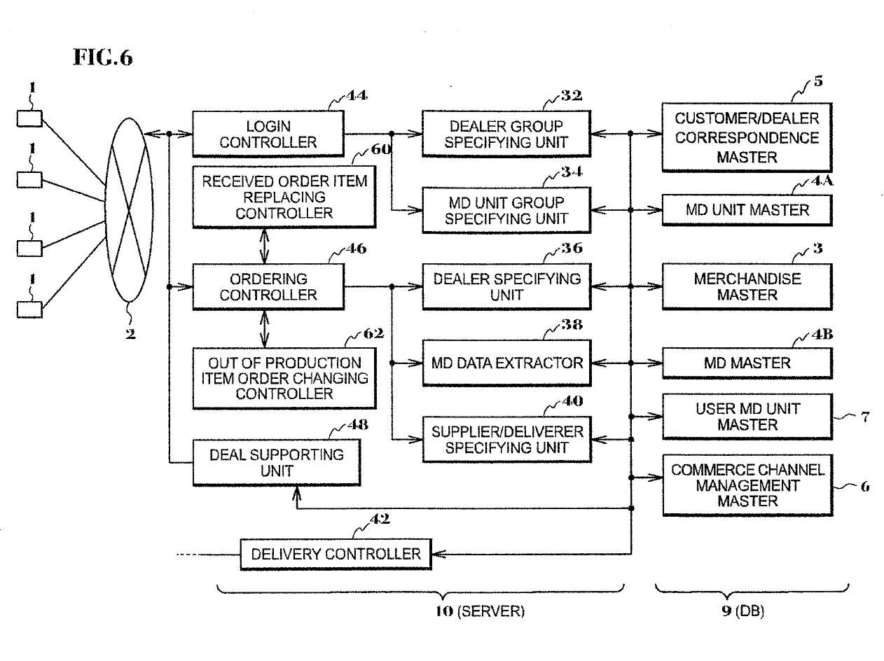

In order to cause the server-implementing computer to function as the deliverer specifying controller 18, moreover, the program for the order placing and receiving system may comprise a deliverer specifying control command for, when an order placement request has been received for placing an order for one or a plurality of items from a terminal used by a user belonging to a purchasing unit, referencing the MD related information for each purchasing unit and specifying a deliverer to provide or deliver goods or services to the user by item number. Thus, in order to implement the configuration diagrammed in FIG. 1 (FIG. 6 in the embodiment) and the operators indicated in FIG. 5, commands should be comprised for effecting those process steps and functions, and the server-implementing computer driven based on those commands. The server-implementing computer, by executing the commands, operates as the various units and functions diagrammed in FIG. 1 and FIG. 2.

Here, when the automatic replace level referencing command and the like are called “commands that cause” the server “to operate,” those commands include either commands that cause the arithmetic processing unit (computer) to operate with the commands alone, or commands that computer to operate in dependence on another program such as an operating system preloaded in the arithmetic processing unit, or both. In the example diagrammed in FIG. 1, for example, the automatic replace level referencing command may be a command that, in dependence on a database retrieval function based on a database server program preloaded in the server 10, passes an MD related information name for identifying MD related information and a retrieval item (automatic replace level) to that retrieval function. Thus there are cases where, for example, only “commands for passing a master name and item name to a database server” are stored in a memory medium for storing that item replacement control program or the order placing and receiving system program, which is a memory medium for carrying such programs to a user. This is determined by the relationship with the operating system or server program or the like of the computer to be operated.

The item replacement control program files and/or order placing and receiving system program files are stored in a portable memory medium 22D and supplied to that computer. This memory medium may be any medium such as a CD-ROM or floppy disk so long as it is capable of storing data in a non-volatile manner. It is also possible to send the programs to an auxiliary memory device via a communication line from another host device.

As described in the foregoing, when the order placing and receiving system is operated using MD related information, the MD related information controls the user group and dealer, and the items (merchandise assortment) handled and capable of being ordered therebetween, wherefore the user can place an order with a dealer determined beforehand by a purchasing management division in an organization, for example, without being aware of who the dealer is at the time of ordering the item. The user, furthermore, can process orders in one batch to a plurality of dealers, wherefore no time and trouble is required for placing orders with individual dealers, nor is it necessary to place orders with different procedures for each retail outlet, as a consequence whereof, order placement work time can be shortened, and the time and personnel costs necessitated for the order placement work can be reduced.

In an example where order placement is controlled by expense item, moreover, orders containing different expense items cease to be passed to an authorization process, while, on the other hand, item groups which one wishes to authorize simultaneously can be authorized as a single batch of orders at the same point in time even if the dealers are different, wherefore the authorization process and budget control are simplified.

By placing orders by expense item, moreover, when order placement processing and verification testing have been performed, those purchase expense items have already been specified, and the order placement and receipt are done by communication with the server, wherefore it becomes easy to access invoice data and the like on line. Hence it is possible to reduce operating costs in fields such as indirect material accounting management and budget control which, while indispensable to business activity, nevertheless are not per se the objects of the main activity of the business.

By using single batch order placement functions, it becomes possible for many dealers to trade with a user group, from which fact an increase in the item categories that can be traded with this order placing and receiving system can be expected. When the item categories that can be traded increase, almost all purchase management of indirect materials and subsidiary materials can be automated merely by the operation of selecting the items.

With this embodiment aspect, furthermore, in order for the item replacing controller 17 to reference the automatic replace level determined beforehand between a customer and a dealer when the MD related information were generated and determine whether or not to implement an item replacement or query a dealer, a person in charge in the purchasing management division of the customer can automatically specify whether or not to do the item replacement for an item replacement that satisfies the predetermined conditions, without having to deal with all of the individual item replacements, and can also, for item replacements within certain conditions, wait for the dealer to give consideration thereto and then implement the item replacement. Thus the daily work load of the purchasing management division can be sharply reduced.

Then, when an attempt is being made to place an order for an old item number for which item replacement has been defined, the item replacement unit automatically switches the order for that old item over to an order for a new item, wherefore the purchasing management division can switch the purchasing activity of the customer over to a new product or to another product that functions similarly without in any way informing the users of the item number replacement. This is advantageous for the users of the customer also, because a switchover is done to anew item, when item replacement has been defined, merely by selecting the item, wherefore the users are able to procure needed new products or replacement products without knowing the details concerning dealer names or items, and also because, when a new item goes out of production, goods having certain functions can be prevented from becoming expended, and goods necessary to operations can be purchased in accordance with the purchasing plans of the purchasing management division of the customer.

The item replacement control disclosed by this embodiment aspect, moreover, can also be applied in a system not having MD related information. Specifically, even in cases where sales are conducted using a catalog or the like, with the items handled and provided to customers fixed, by determining an automatic replace level for every customer, item replacement can be implemented automatically. In that case, the item replacement controller, when making a replacement of an item stored in the merchandise master to a replaceable item, controls the replacement of items provided to the customers in accordance with the automatic replace level predefined for each of those customers. Thus in a system for providing fixed items using a catalog or the like, for example, situations where it becomes impossible to provide items having that function due to items going out of production can be avoided.

### EXAMPLE

An example of a first embodiment aspect is described next with reference to the drawings. FIG. 6 is a block diagram representing an example configuration of a distribution facilitating system based on this embodiment. This distribution facilitating system comprises an order placing and receiving system for implementing such functions as an item specific ordering (batch ordering) function using the MD related information indicated in FIG. 1, an item replacement storing control function based on the item replacement controller, and an item replacement function for switching order placement processing with an old item number to order placement with a new item number when the item replacement is stored. The distribution facilitating system according to this embodiment, besides the functions of the order placing and receiving system for controlling the placement and receipt of orders between this customer and a dealer, also comprises functions for automatically determining the commercial channel from dealer to item supplier, based on predetermined information. For that reason, when a user selects an item, the commercial channel from that item supplier to that user (customer) is automatically determined according to predetermined setting.

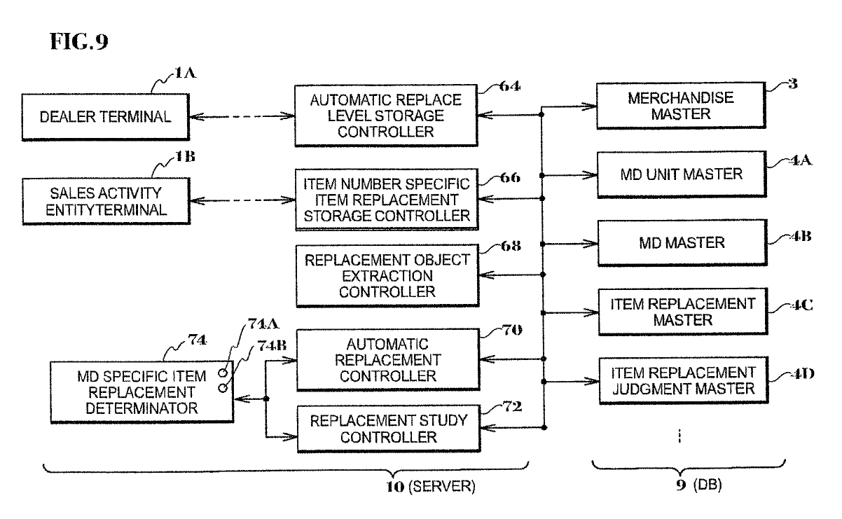

In FIG. 6 is diagrammed that part of the configuration of the distribution facilitating system according to this embodiment which is necessary for the placing and receiving of orders and the specifying of commercial channels using MD related information. A detailed configuration related to item replacement is diagrammed in FIG. 9. In the example diagrammed in FIG. 6, a database 9 for storing various masters, and a server 10 that is connected to prescribed terminals 1 via a network 2, controls the sending and receiving of data with those terminals 1, and extracts data from and stores data in the various masters in response to requests, are comprised. The database, while having many kinds of masters needed to facilitate distribution, in particular, in this embodiment, comprises the masters described below.

(1) Customer/dealer correspondence master 5 to which are defined a plurality of dealers classified by items to the purchase unit of customers regarding the relationship between prescribed purchase units of customers and the dealer providing items such as goods and services to the user belonging to such purchase.

(2) MD unit master 4A, wherein a purchase unit, which is one of the operation units of the user or customer, and the dealer are defined as the key, and to which is defined an MD unit for identifying merchandise assortments of items to be provided from the dealer to such purchase unit.

(3) MD master 4B to which merchandise assortment data is defined as attribute information relating to item distribution, such as the item and supplier and deliverer belonging to the merchandise assortment identified by the MD unit of this MD unit master. The merchandise assortment master 4B stores the expense item code selectable per item.

(4) Merchandise master 3 to which is defined attribute information of the item itself, such as the specification and supplier of such item for each item number of items.

(5) Commerce channel management master 6 to which is defined a middle distributor such as a wholesaler according to the relationship among the dealer and supplier and deliverer.

With the embodiment aspect described in the foregoing, an example was described wherein a merchandise assortment of a dealer for a user group is managed as “MD related information.” In this embodiment, a “merchandise assortment unit (MD unit)” is used to identify merchandise assortments of a dealer for a user group. In merchandise assortment unit information stored in a merchandise assortment unit master 4A, the actual merchandise assortments themselves are not stored. In this embodiment, by combining merchandise assortment unit IDs with item numbers, customer specific electronic catalogs, that is, merchandise assortments (MDs) are defined. These combinations of merchandise assortment unit IDs and item numbers are called merchandise assortments in this embodiment. These merchandise assortments are stored in a merchandise assortment master 4B.

In the present embodiment, the server 10 is equipped with a dealer group specifying unit 32 which specifies a dealer group for every customer's management unit by referring to the customer/dealer correspondence master, and an MD unit specifying unit 34 which specifies an MD unit group for every user or customer's management unit by referring the MD unit master.

Moreover, the server 10 is equipped with a dealer specifying unit 36 which specifies a unique dealer in the dealer group which trades with the user based on the MD data by each of a plurality of MD units specified by the MD unit specifying unit 34 and the item number selected by the user, an MD data extractor 38 which extracts unique MD data which is the MD data uniquely defined for each MD unit for each item number among individual MD data of MD unit group specified by the MD unit specifying unit by the item number based on the item number input by the user for ordering, and a supplier/deliverer specifying unit 40 which specifies a supplier and a deliverer of the item based on the MD data extracted by the MD data extractor.

Also, the server 10 is equipped with a deal supporting unit 48 which specifies a commerce channel from the supplier to the dealer by referring to the commerce channel management master according to the combination of the supplier, deliverer, and dealer, and supports procurement/sales in commerce channels, and a delivery controller 42 which performs a control for delivering the item from the deliverer to the user in the dealer's name. According to the configuration shown in FIG. 5, even when a plurality of dealers (MD units) are defined for a group of users, the commerce channel from the supplier to the customer is automatically determined in the stage when the user selects the item number for ordering.

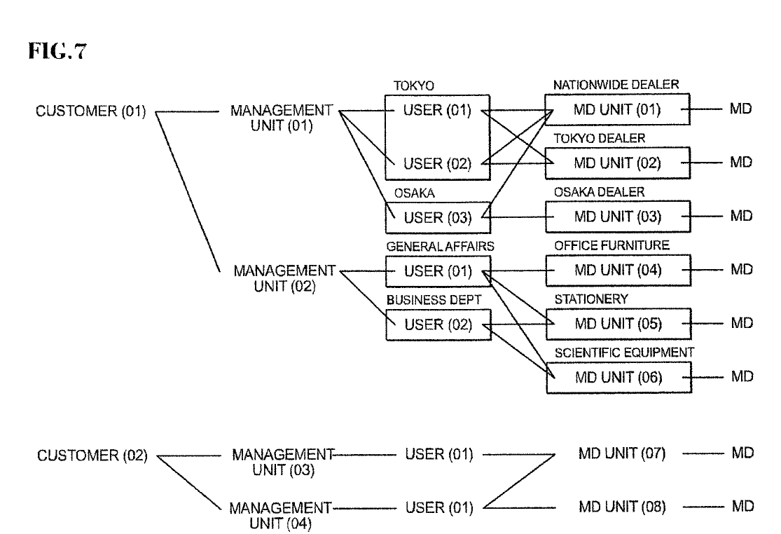

FIG. 7 is an explanatory chart showing the relationship of MD units with each user in the embodiment. In FIG. 7, four management units of customers (01, 02) are shown as an example. The management unit ID attached to each management unit is uniquely assigned to all the customers, suppliers, middle distributors, and deliverers which can be used for mutual identification. Even a middle distributor needs non-production materials to perform its business, and becomes a customer in this case. In the present embodiment, instead of making each company itself to be a trading unit, a unit with a common purchase mechanism is made to be an independent management unit. For example, if the general affairs department and the business department have largely different mechanisms, they are regarded as different management units.

Users belong to each management unit. For example, users (01, 02) who live in Tokyo and a user (03) who lives in Osaka belong to a management unit (01). The number of management units and users are made small with the same explanation. The MD unit (01) of a dealer who is accessible over the entire nation for ordering from all the users. On the other hand, the MD (02) of a Tokyo dealer who mainly covers Tokyo area is accessed by users (01, 02) who live in Tokyo, and the user (03) who lives in Osaka accesses the MD (03) of an Osaka dealer instead of the Tokyo dealer. This is an example where users trade with different dealers depending on their location, even though they belong to the same management unit.

Assume that a user (01) of the general affairs department and a user (02) of the business department belong to a management unit (02), and that, although the user (01) of the general affairs department can order office furniture, authority of the business department does not allow ordering office furniture. In this case, the MD (04) of a dealer who offers office furniture is not accessed by the user (02). The stationery MD unit (05) and the scientific equipment MD unit (06) are set to be accessible in common. In the case of a dealer who offers both office furniture and stationery, the control can be made in such a way that MD units (04) and (05) are united and the user (02) of the business department is blocked from ordering by the unit of individual item.

Also, as in the case of a user (01) of a management unit (03), there is a case where only one MD unit is defined.

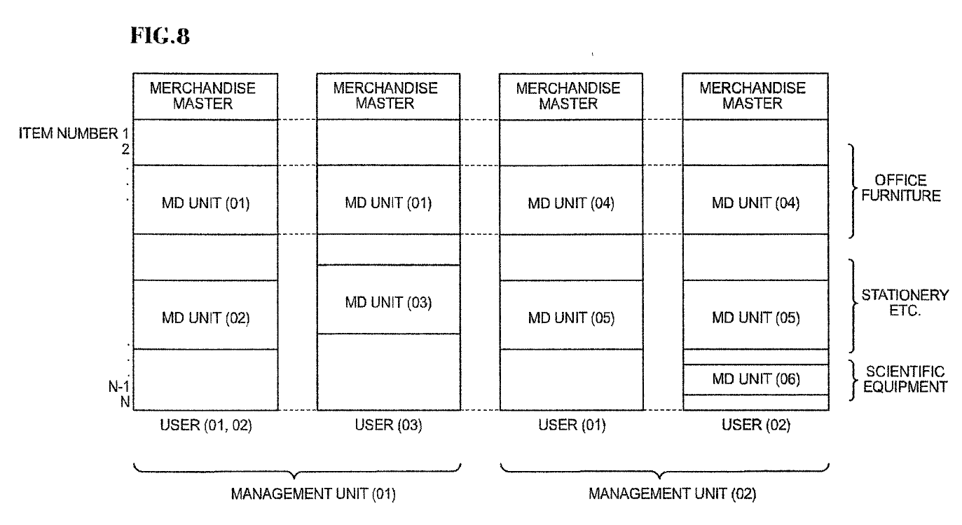

FIG. 8 is an explanatory chart showing the relationship between MD units and item numbers. The merchandise masters shown in FIG. 8 contain all the items handled by the present embodiment (affiliation with other sites is not taken into account here). Then, all the items are identified by unique item numbers. When MD units are investigated with user as the unit, MD units do not have item numbers which overlap with one another. Thus, if an item number is specified by a user, a unique MD unit is specified, and a dealer identified by this MD unit is specified. The MD unit (02) of the users (01, 02) and the MD units of the user (03) partially overlap with each other, and part of them are different from each other. According to differences of dealers' MDs and users' tastes between Tokyo and Osaka, each dealer tries to offer the optimal MD to its customers.

In the example shown in FIG. 8, a group of item numbers (MD) by the MD unit (01) and the MD by the MD unit (04) coincide with each other. However, because MD units are generated dealer by dealer, if dealers are different, even if items of the MDs are the same, different MD units are prepared. Also, if management units are different, different MD units are prepared as well. Because offered prices to the customer and distribution attributes such as the deliverers according to the method of delivery are stored in each MD data, MD units are stored separately by management unit or dealer in this way. MD unit is defined relationship with user belonging to the management unit. User/MD master stored the relationship between user and the management unit.

In the example shown in FIG. 6, the server 10 comprises a login controller 44 for requesting the input of a user ID for identifying a user, password, and a customers management unit ID to which the user belongs, when such user accesses the server. The user is able to log into the server 10 of the distribution supporting system by reading the login page of the distribution supporting system according to the present example and inputting the user ID and customer management unit ID. It is possible to identify the customer management unit to which the login user belongs, and his/her user ID. In this example, the dealer group specifying unit 32 comprises a function for specifying the dealer group capable of providing items to the login user based on customer management unit ID input according to the control of the login controller 44.

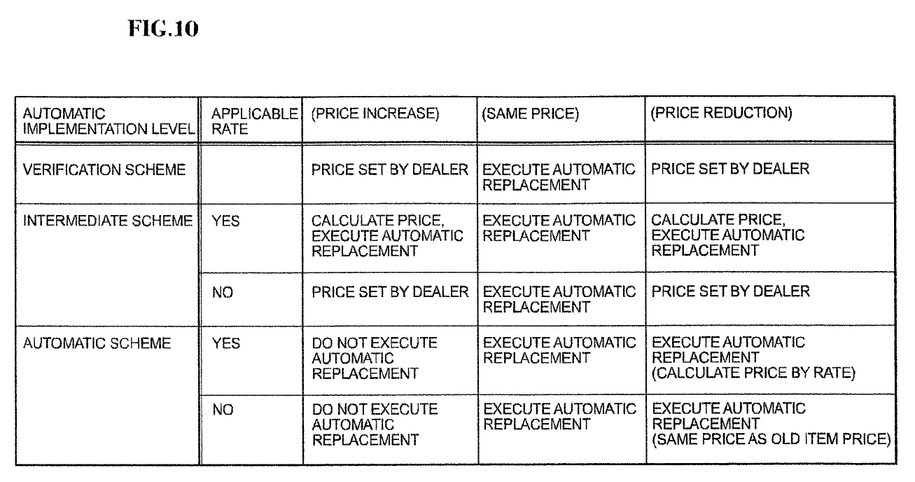

Specified in the customer/dealer correspondence master 5 is on or a plurality of contract dealers (dealer groups) providing items to users belonging to the customer management unit ID and the customer management unit identified by such customer management unit ID. Although it is possible to specify the dealer group by employing the MD related information, in the example shown in FIG. 10, by specifying the dealer group in the login state, it becomes possible to display messages from the respective dealers to such login users, or to determine the existence of dealers that suspended business urgently at the time of login. Further, it is possible for a user belonging to the customer purchase unit to make various inquiries to transacting dealers prior to the selection of items.

Moreover, the MD unit group specifying unit 34 comprises a function of specifying an MD unit group to which is defined a list of items provided to the user per dealer based on the user ID or customer management unit ID input in accordance with the control of the login controller 44. Defined in the user/MD unit master 7 is the relationship between a user ID and MD unit ID. The MD unit group specifying unit 34 specifies the MD unit ID group relating to the login user by referring to the user/MD unit master 7. When this MD unit ID group is distinguished, the login user is able to access all orderable items.

Therefore, when items are searched with the keyword “office cleaning”, it becomes possible to search cleaning tools, which is an MD of a dealer (10), consumables such as electric bulbs which is an MD of a dealer (11), and cleaning service which is an MD of a dealer (13).

Upon referring to FIG. 6, the server 10 comprises an ordering controller 46 for controlling the temporary storage of items numbers of one or a plurality of items ordered by the user as an order item number group. And, the dealer specifying unit 36 comprises a function of determining an exclusive dealer among the dealer group based on the MD unit of the item number specified per item number of the order item number group stored in the ordering controller 46. The maintenance responsible management unit ID in the MD unit master is the management unit ID of the dealer providing the merchandise assortment. The dealer specifying function, in the present example, automatically specifies at the time of ordering the dealer providing items to the user by referring to the maintenance responsibility management unit ID of the MD unit master after the MD unit is specified by the user ID and item number. Here, the dealer specifying unit 36 is capable of specifying such dealer without having to refer to information concerning the dealer group specified by the dealer group specifying unit. Meanwhile, the dealer specified by this dealer specifying unit 36 is one among the dealer group specified by the dealer group specifying unit.

When the item number is determined in a state where the user ID is determined, the MD unit ID can be specified exclusively under the premise that the merchandise assortment is not overlapping. As the merchandise assortment is defined per dealer, an exclusive dealer can be specified from a plurality of dealers by combining the user ID and item number.

The order controller 46, moreover, may be made to comprise an authorization criterion specific order control function 46A that, when authorization criteria have been determined, there is the temporarily stored order item number or order item number group noted earlier, and the authorization criteria for that order item number and for the item number of the item to be newly added differ, prompts the same authorization criterion specific single-batched order placement without accepting the addition of the new item. The working and effects of the authorization criterion specific order control function 46A are the same as those of the authorization criterion specific order control function 16 indicated in FIG. 1.

In the example diagrammed in FIG. 6, the ordering controller 46 comprises functions for controlling the reception of definite orders for order item number groups from the user or another user such as an authorized person. Provision may also be made so that when there has been an authorization for an order placed from an authorized person, a definite order is judged to have been placed for that order item number group. When a definite order has been placed, a supplier/deliverer specifying unit references merchandise assortment data identified by a merchandise assortment unit for that user of the dealer specified by a dealer specifying unit 36 for each item number of the order item number group of the definite order, and functions are comprised for specifying a supplier and deliverer for that item number. That is, in this embodiment, a unique supplier and deliverer are specified by a dealer and item combination. Even in cases where a plurality of suppliers exists, such as fresh flower delivering services or business card printing services, a supplier is specified for each user and each item when the MD related information is generated.

Moreover, the deal supporting unit 48 comprises a function of specifying the middle distributor of the commerce channel, from the supplier to the dealer, as the exclusive distribution path by referring to the commerce channel management master 6 in accordance with the combination of the supplier and deliverer specified by the supplier/deliverer specifying unit 40 and the dealer of such item number. That is, in this example, when the combination of the dealer and supplier and deliverer is determined, the commerce channel from the dealer to the supplier is specified exclusively. In this commerce channel, the dealer specifies a vendor exclusively per item or item group. This vendor further specifies its vendor exclusively. Until the connection of this middle distributor reaches the supplier, such path is exclusive.

By making the deliverer a key of specifying the commerce channel, the merchandise assortment between customers and dealers can be more abundant and flexible. For instance, upon setting a separate item number for ordinary purchases and emergency purchases of copying paper, a deliverer affiliated with the supplier can deliver the copying paper in an ordinary purchase, and, contrarily, the dealer can directly deliver the copying paper to the user in an emergency purchase. Here, the deliverer of the copying paper in emergency situations is the dealer itself. Thus, a commerce channel does not arise. In order to enable various definitions of modes of such deliverer as well as to realize fast and certain automated judgment of the commerce channel during normal operation, the commerce channel is determined in accordance with the combination of the dealer and supplier and deliverer. Further, without limiting the direct delivery from the supplier and by realizing a scheme approximate to the existing commerce channel on the system, items of a wide variety of business lines can be transacted with the distribution supporting system according to the present example. When the types of items increase, the user is able to place orders even more easily with the collective ordering function within the purchase administrative standard, and the scope of automation of accounting processing according to the present example will expand.

Referring to FIG. 6, in this embodiment in particular, the server 10 comprises a received order item replacing controller 60 for, when an order placement request for ordering an item is received from a terminal used by a user belonging to the purchasing unit, referencing the MD related information, and, when a new item number is stored in that item, notifying the user for receiving the order for the item having that new item number, and an out of production item order changing controller 62 for referencing the MD related information, and, when the item number for which the order placement request was made is out of production, urging the user to change or cancel the order for that item. The received order item replacing controller 60 notifies the user for receiving the order for a new item number item when the new item number is stored in the merchandise assortment master 4B that is the MD related information. The received order item replacing controller 60, when a user placing an order has acknowledged that replacement, receives the order with that new item number, whereas, when a decision not to place an order when making a replacement is indicated by a user, controls the suspension of processing that order placement. Provision may also be made so that, when an item replacement has been made, the received order item replacing controller 60 compulsorily switches to the new item number and receives the order in accordance with prior instructions or settings made by the purchasing management division of the customer.

In order for the received order item replacing controller 60 to switch to receiving an order with a new item number when an old item number has been input for placing an order, the replacement of the item is made possible without the necessity of notifying all of the users of the customer of various kinds of information relating to the replacement. In the example diagrammed in FIG. 6, moreover, the out of production item order changing controller 62 references the MD related information, and, when the item number with which the order placement request was received is out of production, urges the user to change or cancel the order placed for that item. In this manner, changes in items after the generation of MD related information can be automatically dealt with.

FIG. 9 is a block diagram representing an example of a configuration relating to item replacement according to this embodiment. As diagrammed in FIG. 9, in the distribution facilitating system according to this embodiment, the database 9 comprises a merchandise master 3 wherein is stored information relating to items provided to customers from dealers, by unique item numbers assigned to those items, an MD related master 4 wherein is stored MD related information that is a list of handled items predetermined, out of the items stored in that merchandise master 3, for each purchasing unit of the customer and for each dealer who provides the items to that customer, an item replacement master 4C for controlling, by item, replacements of item numbers proposed to the customer by a sales activity entity such as a dealer or supplier or the like of items provided to the customer, and an item replacement judgment master 4D for controlling the condition of advance of the item replacements stored in that item replacement master 4C. In this embodiment, the MD related master 4 comprises a merchandise assortment unit master 4A and a merchandise assortment master 4B.

Also, the server 10 comprises an automatic replace level storage controller 64 that, when storing the MD related information in the MD related master 4, stores the automatic replace level for the item replacement determined beforehand between that customer and the dealer in the MD related information, an item number specific item replacement storage controller 66 that, when the replacement of an item number stored in the merchandise master 3 is proposed by a sales activity entity, stores the new item number that is the new item and the old item number of that item replacement in the item replacement master 4C, and a replacement object extraction controller 68 that, after the old item and new item numbers have been stored in the item replacement master 4C, extracts the MD related information wherein is assorted that old item number from the MD related information master. The replacement object extraction controller 68 may also be made to extract MD related information that is to become the subject of replacement in night batch processing.

The server 10, furthermore, comprises an MD specific item replacement determinator 74 that determines whether or not to automatically implement that item replacement, by set of MD related information, based on the automatic replacement implementation level stored in the MD related information extracted by that replacement object extraction controller 68, an automatic replacement controller 70 that, when it has been determined by the MD specific item replacement determinator 74 that an item replacement is to be automatically performed, stores a new item number in the merchandise assortment data specified by the old item number in the plurality of sets of merchandise assortment data in that MD related information, and a replacement study controller 72 that, when it has been determined by the MD specific item replacement determinator 74 that an automatic item replacement is not to be performed, urges the dealer to store information relating to that item replacement and control that MD related information.

In the example diagrammed in FIG. 9, first, an item replacement is proposed by a sales activity entity such as a supplier or the entity managing and operating the order placing and receiving system. The storage of that item replacement is input from the terminal 1B of the sales activity entity to the server 10. At the server 10, the item replacements proposed by this sales activity entity are stored by old item number in the item replacement master 4C. At that point in time, nothing is known of the existence and list of the MD related information wherein the old item number is assorted. Following that, the replacement object extraction controller 68 extracts the merchandise assortment information wherein the old item number stored in the item replacement master 4C is assorted, either periodically by night batch processing or the like, or when replacement information is stored by item number in the item replacement master 4C. Thereby, a list of merchandise assortment units for which it is necessary to determine whether or not to implement item replacement can be extracted.

The MD specific item replacement determinator 74 references the automatic replace level determined for each merchandise assortment unit when the MD related information is generated and stored, and determines whether or not to implement the item replacement. In this embodiment, as diagrammed in FIG. 10, three automatic replace levels are used, namely verification scheme level, intermediate scheme level, and automatic scheme level.

The verification scheme level is an automatic replace level that performs an automatic replacement only when the prices to the customer for the old and new items do not change, and urges the dealer managing that MD related information to input a price when the price of the new item is either higher or lower than the price of the old item.

The intermediate scheme level is an automatic replace level that, when there is a rate and actual amount as the scheme for determining the price to the customer, performs an automatic replacement irrespective of the price difference between the old and new items when that determination scheme is a rate, but urges the dealer managing that MD related information to input a price when the price of the new item is either higher or lower than the price of the old item.

And the automatic scheme level is an automatic replace level that, irrespective of the scheme for determining the price to the customer, determines whether or not to perform an item replacement in line with predetermined classifications according to the price differential between the old and new items, without requiring a price input by the dealer. The predetermined classifications are set so that, as in the example diagrammed in FIG. 10, for example, no item replacement is implemented when the price of the old item is higher than the old item price (a price rise), but the item replacement is implemented when that is a lower price (price decline) When the new item is a low amount and the item replacement is automatically implemented, in cases where the price from the dealer to the customer is defined by a rate, the price of the new item may be calculated with the rate. When the price of the old item is set as an actual amount, on the other hand, if that is made the same amount as the old price, for example, automatic implementation of the item replacement, without requiring study, can be realized.

The MD specific item replacement determinator 74 also comprises an automatic replace level specific determining function 74A for determining whether or not to implement item replacements according to the scheme of the automatic replace level, and a price input control function 74B that, when it has been determined by that automatic replace level determining function that the storing of a price or the like by the dealer is necessary, urges that dealer to store information relating to that item replacement. That is, in this embodiment, by automatically determining whether or not to perform an item replacement and also urging the dealer to effect an operation such as storing a price when a determination cannot be made automatically, the results of the study by the dealer or between the dealer and the customer are awaited.

By employing the automatic replace levels indicated in FIG. 10, a person in charge of the purchasing management of the customer, by merely ascertaining the differences in the three automatic replace levels and making a selection therefrom, can predetermine what response to take to proposals for item replacements arising after the MD related information is generated.

Next, major items of various kinds of masters are explained.

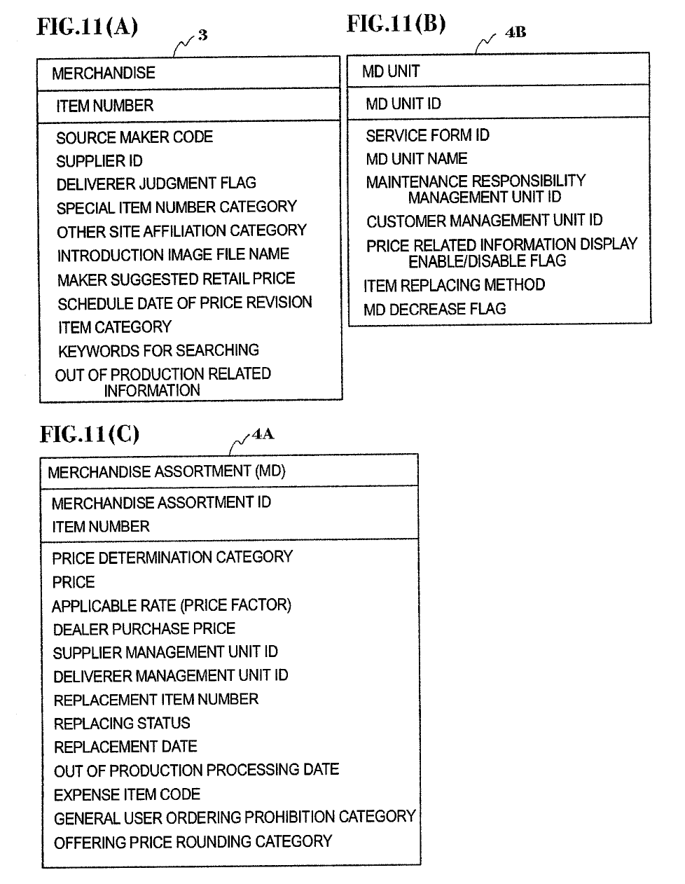

FIG. 11 is an explanatory chart showing examples of representative items of each master. Common to FIGS. 11 to 14, instead of all the items necessary for operating the system, only the necessary items for explaining the present embodiment are disclosed. Also, among the blocks of each master, the first box is the master name, which is an entity, a class, or a table name. The second box items are major keys, and the tables are defined for these items, respectively. The third box are data items input for each table.

FIG. 11(A) is a chart showing an example of items of the merchandise master. In the merchandise master, mainly the information offered from suppliers of goods and services is stored. Information which is different by dealer is not stored in the merchandise master.

In the merchandise master, items of the third box are stored as the item number keys to identify each item. Namely, for one item number, supply source maker code etc. are defined. In the example shown in FIG. 11(C), with a combination of the MD unit ID and item number as keys, offered price etc. are stored for each of this combination.

The merchandise master has, as its items, a supply source maker code used for merchandise control on the supplier side, a supplier ID for identifying the supplier, a plurality of deliverer judging flags indicating delivery-related status pre-determined for each item, such as that absence of a deliverer other than the dealer and specifiable deliverers, a special item number category indicating whether it is a special item number requiring different information from normal items at the time of ordering such as a live flowers gift service and a business cards printing service, another site affiliation category indicating whether it is an item controlled by another site such as the Web site of the affiliated supplier, a plurality of file names of images for introducing the content of the item to the users, a suggested retail prices when it is determined, and a scheduled date for updating this price.

The merchandise master also has a searching keyword and a merchandise category used when a user of a customer searches for necessary merchandise. This merchandise category is what identifies the category of each merchandise such as small classifications such as mechanical pencils, medium classifications such as writing implements, and large classifications such as stationery. There are various kinds of utilization methods of this merchandise category. When defining an expense item in MD data, for example, if stationery is all made an expense item of consumables, there is no need of defining an expense item for each item number, and an expense item can be defined for all items with a small number of operations referring to the merchandise category.

In this embodiment, in particular, out of production related information is stored in the merchandise master.

By storing scheduled out of production dates and classifications relating to out of production items in this merchandise master, an item that is to go out of production can be prevented from being selected when a dealer or the like reorganizes MD related information or generates MD related information. Provision may also be made so that, when the deliverer according to the merchandise assortment information is an ordinary deliverer, whether or not the order can be placed is determined by referencing that scheduled out of production date.

FIG. 11(B) is a chart showing an example of items of the MD unit master. The MD unit is a name of an MD proposed by a dealer to a management unit and selected by a customer. Also, important information for the entire MD is stored in this MD unit, too. In the example shown in FIG. 11(B), the MD unit is stored with an MD unit ID as the key. Also, in the present embodiment, used is a service form ID which identifies the form of the service offered by the system to the customers etc. such as the version of the distribution facilitating system and the distribution facilitating system when the MD is set to be a pre-determined catalog. This service form ID is defined also for the MD unit.

The MD unit has, as its items, an MD unit name such as the name of a merchandise group, a maintenance responsibility management unit ID which is the ID of the management unit of a dealer who has responsibility for maintaining the MD identified by the MD unit and offers each item of the MD to the customers, a customer management unit ID which the user the MD is applied to belongs to, and a price related information display enable/disable flag which indicates whether the price, consumption tax, etc. of the item should be displayed or not in the data communication with the user.

In the case of a large-scale company, there are cases where a purchase subsidiary company exist which collectively controls purchases by the company and its group companies. The dealer to the company is the purchase subsidiary company, and a proposal of the MD is a dealer (a kind of middle distributor) who trades with this subsidiary company. In this case, imagined is an example where maintenance of the MD and providing the actual item are done by a dealer who trades with the purchase subsidiary company. In such a case, in the MD unit master, the dealer specified by the MD unit is better made to be not the purchase subsidiary company but the dealer who trades with that purchase subsidiary company. The dealer who has the purchase subsidiary company as its customer maintains the MD related information according to the agreements with the purchase subsidiary company etc In this case, procurement and billing between the purchase subsidiary company and the dealer who has the purchase subsidiary company as its customer, and procurement and billing from the purchase subsidiary company to the customer is better controlled by another master.

The contents set by the price related information display enable/disable flag applies to all the items of the MD identified by the MD unit.

In this embodiment, in particular, in the merchandise assortment unit master 4A are stored the automatic replace levels indicated in FIG. 10. The automatic replace levels are such as to be troublesome to define for each item, wherefore they are defined for each of the merchandise assortment units that link a customer purchasing unit and a dealer. A merchandise assortment reduction possibility flag is also provided to make it impossible to make merchandise assortment changes in MD related information common to a dealer and a customer based on a set catalog.

FIG. 11(C) is a chart showing an example of items of the MD master. The MD controls the attribute information necessary mainly for distribution of items with a combination of the MD unit ID defined in the MD unit master shown in FIG. 8(B) and the item number as the key. Here, for each item number of the MD identified with the MD unit, there are an offering price calculation method category which specifies a calculation method of offering price from a dealer to the customer, an offering price (in the case of actual amount method), a price factor (in the case of price factor to the purchasing or suggested retail price), a dealer purchasing price which is the price when a dealer purchases it from a wholesaler or a supplier, a supplier management unit ID which specifies the supplier of the item, a management unit ID of the deliverer, and an expense item code which specifies the expense item of the item of the user.

The MD master has, as its items, a general user ordering prohibition category which specifies with a category code (e.g., a number from 1 to 5) whether general users are prohibited from ordering the item from among the items identified by the MD unit or not, and an offering price rounding category which specifies the offering price rounding method, such as for the quantity, when it is offered in a unit of a certain quantity. If a prohibition category code described in the general user ordering prohibition category is stored in the user master, that item is prohibited from being ordered. This is used when the purchase is permitted for only those who have a certain budget authority, purchase by a specified department is prohibited, etc.

When an MD related information is mentioned, it means that information of this MD unit master and the MD master are united in one. Namely, the MD related master data in the present embodiment are equipped with an MD unit master and an MD master. When a plurality of MD units are defined for a purchasing unit, if they are defined so that items which can be handled by the plural number of MD units to the purchasing unit do not overlap among the MD units, group ordering to a plurality of dealers is easy to perform. This group ordering is also an item specific ordering function where dealers are divided by item.

In this embodiment, in particular, new item number, replacement status, replacement implementation date, and out of production processing date are provided as merchandise assortment master 4B data items. The new item number, which constitutes data stored in the merchandise assortment master 4B by the automatic replacement controller 70 or the like, becomes basic information for replacing that item number with a new item number. In an example using the data structure diagrammed in FIG. 11(C), when a new item number is stored, and the replacement status is “replacement being implemented,” the item replacement is performed. This new item number and replacement status are referenced by the received order item replacing controller indicated in FIG. 6.

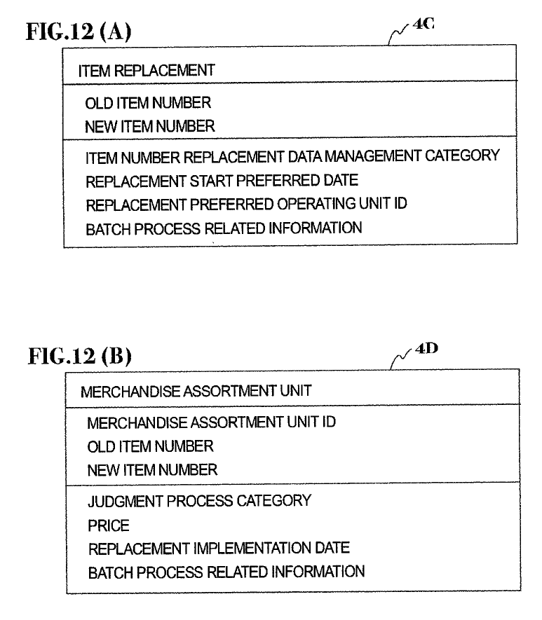

The replacement implementation date is the date that the implementation of an item replacement is to be started when it has been determined that such will be performed. When a query is sent to a dealer, that replacement implementation date is stored. When an item replacement has been automatically determined, on the other hand, that date may be stored after referencing a replacement start preferred date stored by the sales activity entity indicated in FIG. 12(D).

FIG. 12(A) is a diagram representing example data items for the item replacement master. The item replacement master 4C has an old item number and new item number as data items that become key. For each combination of old item number and new item number there is an item replacement data control category, replacement start preferred date, replacement preferred operating unit ID indicating the operating unit ID of the supplier or dealer or the like that indicated the replacement preference, and batch related information for storing information related to batch processing. When the supplier wants a new item replacement, for example, the old item number and new item number are stored in this item replacement master. Then a “0” indicating a new storing is stored in the item replacement data control category. When this item replacement master has been referenced by the replacement object extraction controller 68 indicated in FIG. 9, for example, and one merchandise assortment unit group wherein that old item number is assorted has been extracted by a batch process or the like, the item replacement data control category is made “1.” Accordingly, the replacement object extraction controller 68 performs the extraction of MD related information for that for which the item replacement data control category in the item replacement master 4C is “0”. When canceling an item replacement, moreover, that item replacement data control category is made “2.”

The replacement start preferred date is a scheduled date on which item replacement can be started by a supplier. The batch process related information is such as a batch processing date for extracting a merchandise assortment unit or the like or the person in charge of batch processing or the like.

FIG. 12(B) is a diagram of data item examples for the item replacement judgment master. The item replacement judgment master 4D has merchandise assortment unit ID, old item number, and new item number as the key data items therefor. The item replacement judgment master 4D, moreover, comprises a judgment process category for controlling the condition of item replacement advance related to item replacements for each merchandise assortment unit, a new item price either stored by a dealer or automatically calculated from a predetermined rate or the like, a replacement implementation date determined by a dealer or by a sales activity entity desiring an item replacement, and batch process related information.

The item replacement judgment master 4D is referenced by the MD specific item replacement determinator 74 indicated in FIG. 9, used when classifying automatic replacements for item replacements or waiting for the judgment of a dealer. In the judgment process classification of the item replacement judgment master, “0” is stored when automatic replacement is to be done, and “1” is stored when waiting for a query to be made to a dealer or for a price to be input by a dealer, or the like. When the judgment process classification is “0,” the automatic replacement controller 70 indicated in FIG. 9 processes the replacement. When the judgment process classification is “1,” however, the replacement study controller 72 processes the replacement. When the MD specific item replacement determinator 74 references an automatic replace level or the like, and determines not to perform an item replacement, this item replacement judgment master 4D does not generate.

The automatic replacement controller 70, when the item replacement judgment master 4D judgment process classification is “0,” first retrieves the merchandise assortment master 4B from the merchandise assortment unit and old item number, and operates on those merchandise assortment data items as follows. That is, first, the new item number is stored. Then the replacement status is made “3,” that is, implementation in process. Provision may also be made so that, at that time, the replacement status is made implementation in process after the replacement implementation date has been reached. Furthermore, new merchandise assortment data are stored, referencing the merchandise master, using that merchandise assortment unit and new item number as keys. Provision may be made so that, when both the old item and new item have the same supplier, a commercial channel that is the same as the commercial channel for the old item is stored in the merchandise assortment data for the new item. Provision may be made so that, when the supplier is different for the old item and the new item, on the other hand, the dealer is prompted to store a commercial channel or the like. When the storing of information relating to item replacement is finished, the data that stored the item replacement related information are deleted from the item replacement judgment master 4D.

When the judgment process classification in the merchandise assortment judgment master is “1,” and a dealer judgment is being waited for, first, a verification is made as to whether or not a price for the customer of the new item has been input by the dealer. When a price has been stored, the corresponding merchandise assortment data are read out of the merchandise assortment master, and the item replacement related information are stored That is, the new item number is stored in the old merchandise assortment data, the replacement status is made implementation in progress, and the new item number is stored as new merchandise assortment data. After that, the data that have been completely stored are deleted from the item replacement judgment master 4D.

The canceling of item replacement information is described next. When a sales activity entity such as a supplier cancels a proposed item replacement, first, a “2” indicating cancellation is stored in the item replacement data control category in the item replacement master 4C. Then, the MD related information having the old item number is extracted. When MD related information that is to be the object of the item replacement has been specified, a “2” indicating cancellation is stored in the judgment process classification of the merchandise assortment judgment master. The MD specific item replacement determinator 74, when an item replacement cancellation is indicated in the judgment process classification, clears the new item number and replacement status in the corresponding MD related information. When that is done, the item replacement is cancelled. Depending on the embodiment, moreover, provision may also be made so that, even when an item replacement is cancelled, the new merchandise assortment information is not deleted, and it is made possible to place an order with a new item.

Here, an example wherein an order is placed and received with item replacement using the merchandise assortment master data items indicated in FIG. 11 is described. When a user logs into the order placing and receiving system, or a distribution facilitating system comprising such system, and specifies an item, the merchandise assortment unit is specified from the item number thereof and user ID, and a dealer is specified. When the merchandise assortment is specified, a judgment is made on whether or not to perform an item replacement. In specific terms, a determination is made as to whether or not the replacement status is implementation in progress. If there placement status is implementation in progress, the new item number is readout, and specified. Following thereupon, from the new item number, merchandise assortment data for that item number are accessed. From that new merchandise assortment data, a price and the like are obtained. Then, from the new item number, the merchandise master is retrieved, and the goods specifications and descriptive images and the like are retrieved. A display is made to the user notifying that the item replacement has been generated.

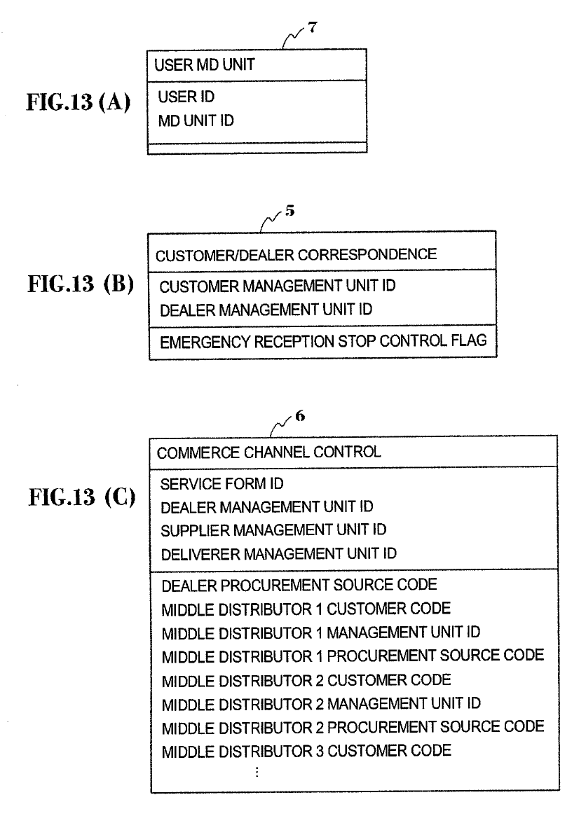

FIG. 13(A) is a diagram representing data item examples in a user/merchandise assortment unit master. The user/merchandise assortment unit master 7 has user ID and merchandise assortment unit ID as its data items. That is, for a user ID, the merchandise assortment unit group accessible by that user is designated. The user/merchandise assortment unit master 7 also designates the user group that accesses the merchandise assortment unit. FIG. 13(B) is a diagram representing data item examples in a customer/dealer correspondence master. The customer/dealer correspondence master 5 is stored with an operating unit ID and dealer operating unit ID as keys. That is, when the operating unit ID of the customer is determined, the dealer group is specified. When the dealer operating unit ID is determined, moreover, the customer operating unit group that is to become the customers of that dealer can be specified.

FIG. 13(C) is a diagram representing data item examples in the commercial channel control master. The commercial channel control master is used for specifying intermediate commercial channels between dealers, suppliers, and deliverers. The commercial channel control master 6 has service form ID, dealer operating unit ID, supplier operating unit ID, and deliverer operating unit ID as keys. Accordingly, commercial channels are not defined for each item but intermediate commercial channels are specified according to combinations of those three entities. The commercial channel control master also has, as a data item thereof, a dealer supplier code that becomes the direct supplier of the dealer. In addition, using a middle distributor 1 customer code (dealer operating unit ID), middle distributor 1 operating unit ID, and middle distributor 1 supplier code (supplier or middle distributor which becomes direct supplier of middle distributor 1), a combination of this customer, operating unit, and supplier is defined for each player. When the supplier operating unit ID is specified by a supplier code, the commercial channel is finished as a unique channel. In many cases the pattern of this commercial channel is predetermined, and, in the generation of the MD related information, this commercial channel control master is generated, based on that pattern.

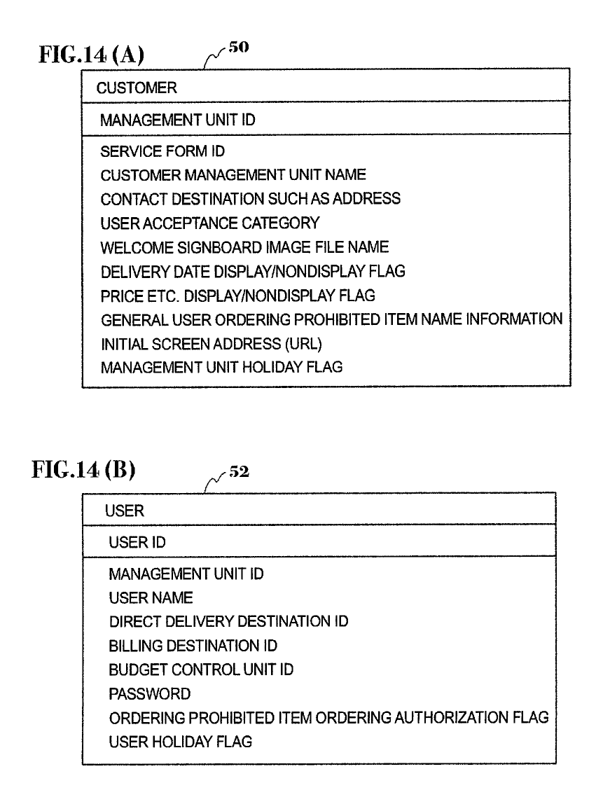

FIG. 14 is a diagram of data structures for managing customers and users. In this embodiment, users belonging to an operating unit make invoices in employee position units, but budgets are in units of projects which cut across positions laterally, and there are cases where, even if the position is the same, the offices are dispersed, and the destinations to which items are provided and sent differ. These relationships are of various forms from one organization to another, wherefore it will be well to make where a user belongs a multiplexed succession, and separately control users and parties invoiced, users and budget control units, and users and delivery destinations and the like.

FIG. 14(A) is a diagram representing data item examples in a customer master. The customer master is stored with the operating unit ID (customer operating unit ID) as key. In the customer data items are stored data relating to purchasing as applying to that operating unit overall. The user master 52, on the other hand, is stored with the user ID as key, and in the data items thereof are stored data relating to various personnel assignments within that operating unit. The holiday flag is used in making delivery date calculations.

According to this embodiment, as described in the foregoing, the automatic replace levels are made to be in three types, and, merely by specifying one of those three when generating MD related information, the subsequent item replacement implementation scheme can be controlled, pre-allowed item replacements are implemented automatically, and, for item replacements not falling under disallowed conditions, a determination of “do not replace item” can be made automatically without requiring a judgment by the customer's purchasing management division. By so doing, the load on the purchasing management division can be reduced. For the customer user himself or herself, moreover, the probability of procuring suitable goods is raised by the implementation of item replacements, and, furthermore, the user, merely by selecting an old item, can procure the new item without having any knowledge whatever of item replacements or dealers or customer purchase conditions or the like. And it is also possible for a supplier or other sales activity entity to tender a proposal, through the system, expressing the wish to switch to a new item, wherefore measures can be taken regarding goods that should be manufactured and sales campaigns and the like can be implemented for new goods without waiting for the periodic purchase agreement to be updated.

Second Embodiment Aspect

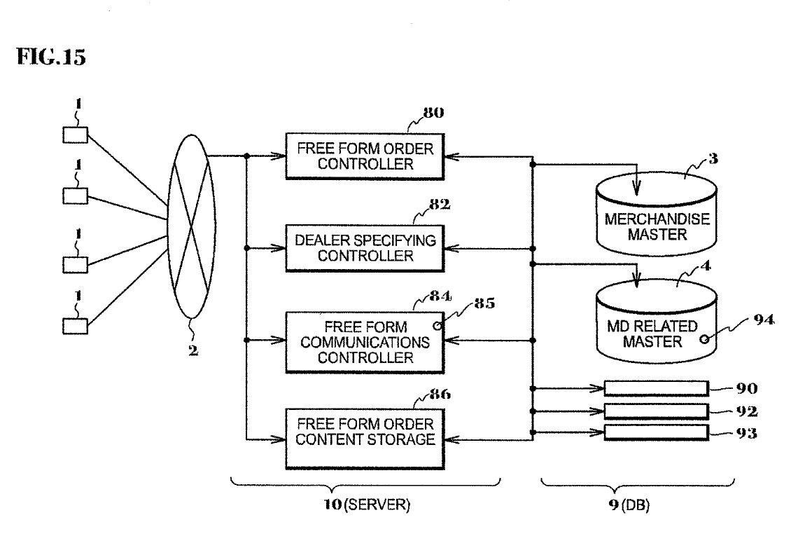

A second embodiment aspect of the present invention is described next. In this second embodiment aspect is disclosed a procedure for a user to procure items (goods or services) not stored in MD related information. An order placing and receiving system based on the second embodiment aspect, as diagrammed in FIG. 15, comprises a database 9 wherein are stored various kinds of master, and a server 10 that is connected via a network to customer terminals for use by a customer and dealer terminals for use by sales outlets or other dealers, controls the sending and receiving of data with those terminals, and extracts and stores data from and to the various masters in response to requests from the terminals. The database 9 also comprises a merchandise master 3 wherein are stored data relating to items such as goods or services provided to a customer from a supplier via the dealer, by item numbers that are unique to those items, and an MD related master 4 wherein is stored MD related information that is a list of items handled, predetermined for each purchasing unit of that customer and for each dealer providing items to that customer, among the items stored in that merchandise master 3. The database 9 may also be made to comprise the same various kinds of master as in the first embodiment aspect.

The server 10 based on this embodiment aspect also particularly comprises a free form order controller 80 that, when an order is placed from a customer terminal for an item not stored in the MD related information oriented toward that customer of one or a plurality of dealers, controls the placement or orders or request for an estimate in a free form for the dealer group having the MD related information oriented toward that customer, and a dealer specifying controller 82 for prompting the customer to specify a dealer for providing to that customer an item ordered by the free form order controller 80, or for which an order placement is expected, from a plurality of dealer groups.

With the second embodiment aspect, as with the first embodiment aspect, by using MD related information, the placing and receiving of orders in a mixed condition having a plurality of customers and a plurality of dealers on a network or system is controlled. With the second embodiment aspect, when an order is placed from a customer terminal for an item not stored in the MD related information oriented toward that customer of one or a plurality of dealers, the free form order controller 80 controls the placing of the order or estimate request in a free form for the dealer group having the MD related information oriented toward that customer. That is, by allowing orders to be placed only to a dealer group selected beforehand by a purchasing management division, purchasing management and the integrity of the order placing and receiving system are maintained.

The dealer specifying controller 82 effects control to prompt the customer to specify a dealer for providing to that customer an item ordered by that free form order controller 80, or for which an order placement is expected, from a plurality of dealer groups. When placing and receiving orders using the MD related information, a dealer was prescribed based on the user and item number, but, in the case of free form, the designation of the user is waited for, and then the dealer is specified. The dealers capable of being specified are dealers having MD related information oriented to the customer to which that user belongs.

In the example diagrammed in FIG. 15, the server 10 comprises a free form communications controller 84 that controls communications between dealer terminals specified by the dealer specifying controller 82 and the terminals of customers placing orders for items by the free form order controller, and tenders requests to the customer terminal or dealer terminal, according to the category of that data item, by those communications, to input data items that are roughly the same (either completely the same or having the same main parts even though one part is different) as the data items stored in the MD related information. The data items stored in the MD related information are, for example, the data items indicated in the merchandise assortment unit master 4A and merchandise assortment master 4B indicated in FIG. 11. Data items such as price, supplier, and deliverer or the like are stored by the dealer, for example. The expense item code is an important data item the customer user is requested to input.

In a preferred example, the free form communications controller 84 will comprise an expense item input control function 85 for prompting for the input of expense items (expense item codes) of items for which that free-form order placement is made to the customer terminal. When the user is requested to append an expense item to an item by free-form order placement, in order that expense items be appended to all the items including free-form ordered items, in cases where authorization is made, or cases where budget control is performed for each budget control unit (which can be specified by user and expense item), pre-assorted items and items based on free form can be controlled together in one batch. By an expense item code being appended, moreover, accounting classifications and the like are made easy even for free-form ordered items.

Provision may also be made so that whether or not free-form ordering is enabled is determined by customer purchasing unit or by user. In that case, it will be well for the database to comprise purchasing unit specific free form order enable/disable data 90 that specifies whether or not to enable operations of the free form order controller for the customer or for each purchasing unit of that customer, or user specific free form order enable/disable data 92 that specifies whether or not to enable operations of the free form order controller by user belonging to a customer purchasing unit.

Provision may furthermore be made so that categories of items or item groups capable of being free-form ordered at the dealer's end are specified, and so that, in cases where a user places a free form order, when a service or other item has been specified, a dealer capable of providing that item is specified In that case, it will be well for the database to comprise dealer specific free form order capable item group data 93 for specifying item categories or item groups that can be free-form ordered at the dealer's end.

With order placement and receiving wherein MD related information is used, trade talks are not conducted with a dealer to negotiate prices and the like. In the case of cleaning request services, moving services, and custom ordered items and the like, however, it is necessary to conduct trade talks with the dealer concerning prices and other particulars. In this embodiment having the free form order controller 80, it will be well that the MD related information comprise a free form conforming order control flag 94 for prompting a free form conforming order placement that conforms with the free form for items that change individually for every order placement and receipt in terms of the particulars and price of the item. Thereby, it is possible to assort the item cleaning service, and, when an order has actually been placed, service details and prices and the like can be determined in conformity with the free form case. By making the system such that, prices and dealers, as a general rule, are determined beforehand as MD related information, and prices and service particulars are negotiated with free form conformable order placement on an exceptional basis, costs invisible to the customer purchasing management division and users can be reduced.

With free-form ordered items, except in the case of free form conformable order placement, it is presupposed that no merchandise has been assorted in the MD related information. In accordance with the control of the free form order controller 80, moreover, of the content once ordered, it is conceivable that some part thereof be reordered. In that case, the user sets the expense items and the like, and, in view of the fact that price negotiations and the like with the dealer have been concluded, when an item for which a free form order was placed is stored in the MD related information as a merchandise assortment, the convenience to the customer's user is enhanced. In this example, the server 10 comprises a free form order content storage controller 86 that, after an order placement has been made definite by the free form order controller, effects control for storing the particulars of that order in the MD related information. The free form order content storage controller 86 is used by dealers, for example. Provision may also be made so that whether or not to store these free form order particulars is controlled by free form order content storage implementation levels that are like the automatic replace levels of the first embodiment aspect. These free form order content storage implementation levels are negotiated between customer purchasing management divisions and dealers.

With the second embodiment aspect described in the foregoing, it is possible to place orders in free form also for items not contained in MD related information, wherefore, even when the merchandise assortment is inadequate in the MD related information, items required for the business operations of the customer can be procured using the order placing and receiving system. Accordingly, when the order placing and receiving system is linked with authorization, budget control, and accounting and the like, it becomes possible to effect unified integrated management with ordinary expense items by requesting the user to input an expense item code when placing a free form order. In terms of purchase management, also, a person in charge in the purchasing management division can, by making the merchandise assortment less, and allowing after-the-fact free form order placement to all users, automatically generate merchandise assortments, while conducting budget controls, and, conversely, by defining merchandise assortments based on purchase performance, and authorizing only the purchasing management division to make free form order placement, it is also possible to manage items particularly desired in a single batch by the purchasing management division, while placing orders for limited items. Thus, by using the free form order placement functions, an order placing and receiving system can be built which deals flexibly with exceptional orders while performing order placement and receiving based fundamentally on the MD related information. By the free form order placement according to this second embodiment aspect, items wanted by the user of a customer can be added to the merchandise assortments, and, by item replacement based on the first embodiment aspect, items wanted by suppliers and the like can be reflected in the merchandise assortments, wherefore subsequent operations can be performed well, without performing the generation of MD related information rigorously, and, for that reason also, management costs in the purchasing management division can be reduced.

Third Embodiment Aspect

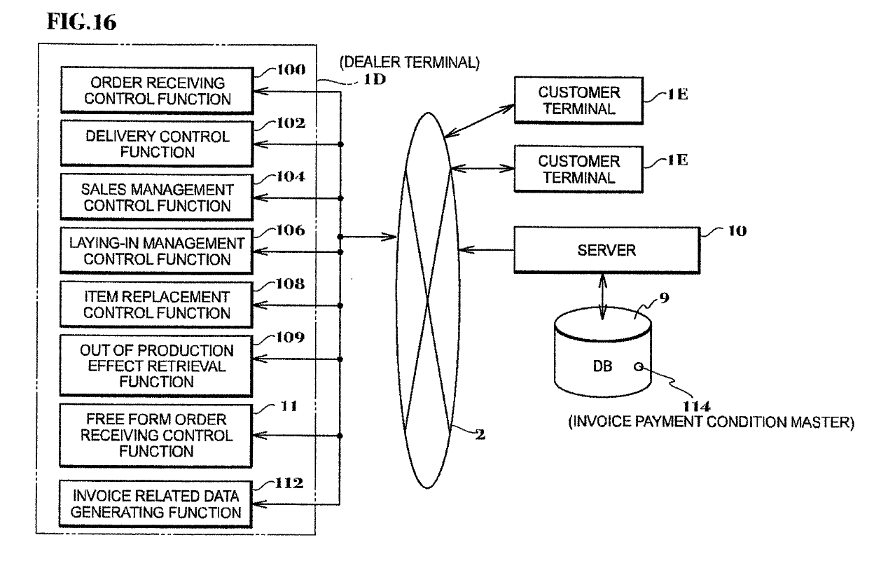

A third embodiment aspect is described next with reference to the drawings. In the third embodiment aspect, order placement and receipt using MD related information, item replacement, and free form order placement as centered on a sales outlet (dealer) are disclosed. That is, it is disclosed that the order placing and receiving system described above is an application service provider (ASP) system oriented to the sales outlet (dealer). FIG. 16 is a block diagram representing an example configuration of a dealer's ASP system based on this embodiment aspect. As diagrammed in FIG. 16, the dealer's ASP system according to this embodiment aspect comprises a database 9 wherein are stored various types of master such as a merchandise master wherein is stored information relating to items that are goods or services, and a server 10 that is connected via a network 2 such as the Internet with terminals 1E and ID, controls the sending and receiving of data to and from those terminals 1E and ID, and extracts or stores data from or to the various masters, according to requests made by those terminals. The dealer's ASP system also provides order placing functions to the terminals 1E of one or a plurality of users belonging to the purchasing unit of a customer, and provides order receiving functions to said terminals ID of the plurality of dealers that provide items identified by item number to that customer. The various masters comprised by the database 9, and the data items therein, are the same as in the first embodiment aspect and the embodiments thereof.

The terminals 1E and ID are terminals for displaying pages sent from a server, and sending various requests to the server 10 in response to the activation of execution buttons or links in those pages. These terminals 1E and 1D are computers or portable terminals, for example, which receive and display pages written in a mark-up language such as HTML. Hereinafter, a terminal used by the ASP system is called a browser terminal. In the example diagrammed in FIG. 16, the browser terminal used by a customer user is called the customer terminal 1E, and the browser terminal used by the dealer is called the dealer terminal 1D. The server 10 sends a page written in a mark-up language such as HTML or XML to the browser terminals 1E and 1D, retrieves data input via that page, and, according to data input via that page, and to the activation of execution buttons and the like on that page, retrieves data stored in the various masters, and generates pages, and sends those generated pages to those browser terminals, and thereby provides various functions to the browser terminals 1E and 1D that are computers or portable terminals or the like. It will be well for the terminals to have communication control functions for controlling communications with the server 10 and browser functions for interpreting and displaying the prescribed mark-up language, and similar functions can be effected on the terminals by communicating with the server 10 as when application software has been installed in the terminals.

With such server functions as these, at the customer terminal 1E and the dealer terminal ID, with only the functions for displaying a page, the activation of execution buttons for links or various kinds of buttons and the like contained in a displayed page, and functions for sending input particulars to the server, various and sundry functions can be implemented. In this embodiment, the server 10 provides various kinds of functions to the dealer terminal 1E using procedures for sending and receiving pages and the like based on that mark-up language. Specifically, the server 10 provides, to the dealer terminal 1E, an order receiving control function 100 that, when an order has been placed for one or a plurality of items from the customer terminal, for each item, makes an item stored in the MD related information for that customer of that dealer an order received by that dealer, a delivery control function 102 that controls the arrangements for transferring the one or plurality of items for which order was received by the order receiving control function 100 based on data stored beforehand in that MD related information, a sales management control function 104 for controlling the accounting of sales by that dealer to that customer in response to the arrangements made by that delivery control function 102, and a laying-in management control function 106 for controlling the accounting of dealer laying in related to those items based on data stored beforehand in the MD related information.

The order receiving control function 100 is a function that, for example, even in a case where a user of the customer has placed a batch order for items handled individually by a plurality of dealers, divides those orders by dealer with the server 10, and, if the item is contained in a merchandise assortment according to the MD related information of that dealer, makes that an order received by that dealer. By this order receiving control function 100, the user of the customer can execute single-batch order placement processing without any knowledge of the relationships between the items and the dealers. The dealer also, by keeping MD related information in good order, can automate item order receiving, and thus no longer needs to perform work for receiving regular periodic orders. In order to implement this order receiving control function 100, it is preferable that the dealer terminal 1D comprise, as a function provided by the server 10, a related information storing function (not shown) that stores, for each purchasing unit to which a user of a customer belongs, a list of items provided to that purchasing unit, as MD related information, for each purchasing unit of that customer.

In the example diagrammed in FIG. 16, the dealer terminal 1D comprises, as functions provided by the server 10, an item replacement control function 108 that, when replacements are made with items stored in the merchandise master 3 to items that are capable of substitution and contained in the MD related information, controls the replacement of items provided from the dealers to the customers in accordance with the automatic replace level defined beforehand in the MD related information, and a free form order receiving control function 110 for receiving orders of items which were ordered by free form from the terminal of a customer but are not stored in the MD related information oriented toward that customer, and the like.

The item replacement control function 108 is item replacement according to the first embodiment aspect and first embodiment. The free form order receiving control function 110 is the free form order placing and receiving function according to the second embodiment aspect. By having these functions 108 and 110, it is possible to reduce the work load on dealers relating to receiving exceptional orders after the MD related information (merchandise assortment unit master and merchandise assortment master) has been generated. Also, by having the free form order receiving function, items other than those contained in the merchandise assortment can be controlled in a single batch by that ASP system, wherefore the scope of automation of invoicing operations and the like from dealers to customers can be broadened.

It will also be well for the dealer terminal 1D to comprise, as a function provided by the server 10, an out of production effect retrieval function 109 for, in cases where an item stored in the merchandise master has been taken out of production, retrieving the MD related information wherein that item is defined from that database. There are cases where an item is taken out of production by a supplier or by a dealer. An item stored in the merchandise master may be taken out of production, for example, by the supplier suspending manufacture thereof Cases also arise such as where a dealer wishes to replace an item, or where the receiving of orders for some item is urgently needed to be stopped in response to any of various factors. In such cases as these, conventionally, it has been troublesome to retrieve the customers (or customer purchasing units) having that item in a handling list (merchandise assortment) of a periodic purchase agreement or the like, and it was not possible to quickly retrieve the effects of a product going out of production. The out of production effect retrieval function 109 according to this embodiment aspect is a function that, when notification has been made of an item scheduled to go out of production by a supplier, or a dealer decides not to handle some product, retrieves the MD related information having that item (item number) With this out of production effect retrieval function 109, customer purchasing units assorting items subject to being taken out of production can be automatically specified.

The out of production effect retrieval function 109 may have a function that, when notification has been made of the scheduled taking out of production of an item from a supplier, for example, or the merchandise master has been renewed, retrieves the MD related information having the item number of that item by batch processing or the like, and notifies the dealer of the results of that retrieval. Thus, even in a such case as where, with the scheduling of an item going out of production notified 6 months earlier, for example, no item replacement has been proposed by a supplier, the dealer can consider and propose an item replacement for each purchasing unit of a customer before the fact. The out of production effect retrieval function 109 may also comprise a function that, when the receiving of orders for an item needs to be urgently stopped by a dealer or supplier, retrieves the MD related information wherein that item to be urgently stopped is assorted, and reflects the stopping of the receiving or orders for that item in the MD related information. In examples having the out of production effect retrieval function 109, moreover, the item replacement control function 108 reflects an item replacement that changes the item going out of production to another item in the MD related information of each of the purchasing units of that customer.

Functions relating to sales, laying in, and invoicing are described next. With an ASP system based on this embodiment, transactions for monetary amounts according to order placement constitute purchasing data from the customer's perspective, but accounts receivable data from the dealer's perspective. The provider of an application service, moreover, from the perspectives of that customer and dealer, is a third party entity, and executes transactions concerning money amounts with this ASP. Accordingly, it is easy for the customer and dealer to mutually rely on the results of executing that transaction (invoice amount and payable amount), and it is easy for the customer and dealer to reduce the work involved in matching those settlement items. As diagrammed in FIG. 11(C), moreover, by determining the dealer lay-in price (actual amount or rate) by which the dealer lays in goods from a wholesaler or the like at the time the MD related information is generated, the accounting related work associated with laying in can be automated. Accordingly, for an order placed from some user to a dealer, the price to the customer to whom that user belongs and the dealer lay-in price are calculated by the ASP system. Also, as diagrammed in FIG. 14(B), for example, if the party to whom an invoice from a customer to a dealer is issued is defined ahead of time in the user master 52 as an invoice recipient ID, the issuance of invoices from the customer to the dealer can be done automatically by the ASP system. Provision may also be made so that a direct delivery destination ID for that user master is referenced, and the item itself is directly delivered from a deliverer managed by the supplier to the employee position or the like indicated by that direct delivery destination ID (delivery control function 102). In that case, delivery to the direct delivery destination with the dealer's name applied to the statement of delivery can be done.

Thus, using the ASP system based on this embodiment aspect, a dealer can receive issuances and the like of orders received and invoices from the ASP system without performing any active work whatever relating to individual order receipts or sales.

The sales management control function 104 indicated in FIG. 16 controls the accounting of sales of a particular dealer to a particular customer according to the arrangements made by the delivery control function 102. As to whether to account sales from when delivery to a customer first begins, or when the delivery is made to the direct delivery destination of the customer, or when acceptance (verification of contents of delivered goods) has been concluded by the customer, that may be determined between the customer and the dealer when generating the MD related information. The laying-in management control function 106, moreover, controls the accounting of dealer laying in relating to a particular item, based on data (such as the dealer lay-in price, for example) stored beforehand in the MD related information. That is, for an item ordered by the user of a customer and delivered by a deliverer managed by the supplier, the dealer, in terms of distribution, lays in goods from a commercial channel player such as a wholesaler, delivers the goods to the customer, and issues an invoice from the dealer to the customer. The dealer pays the lay-in price of the wholesaler or other commercial channel player. The laying-in management control function 106 manages the laying in of that dealer from the wholesaler.

In invoicing between a customer and a dealer, in general, a certain day of the month is made the closing day, and the transactions from the day after the closing day to the closing day of the next month are totaled and the total of those prices is invoiced out. In the example diagrammed in FIG. 16, the database comprises an invoice payment condition master 114 that, using an invoice recipient predetermined for a user belonging to a purchasing unit of the customer and an invoice originator predetermined by the dealer as keys, specifies the invoice payment conditions determined beforehand between that invoice recipient and invoice originator. An invoice related data generating function 112 is also comprised, as a function provided by the server 10 to the browser terminal used by the dealer, that references the invoice payment condition master, references that predetermined closing day, references invoice criteria such as delivery to the customer or acceptance by the customer, and generates data relating to invoices from the dealer to the customer for one or a plurality of orders placed and received.

There are various possible forms for invoicing a customer from a dealer. First, it is a general practice to account dealer sales when delivery is made of individual items. For invoicing, on the other hand, due to the relationship with the closing day, there are two forms, one based on whether delivery was made by the closing day (delivery date criterion), and the other on whether acceptance was made by the closing day (acceptance day criterion). In the relationship with the order placing unit, moreover, there are two forms, depending on whether it is possible to invoice for all orders placed in one order (one voucher) that have been delivered or accepted (voucher units), or possible to invoice item by item that has been delivered or accepted (specific units).

With this embodiment aspect, one of the four invoice payment verification schemes noted below is specified between the customer and dealer when generating the MD related information, and stored as the invoice payment conditions in the invoice payment condition master 114.

1. Delivery date criterion, specific unit verification scheme

2. Delivery date criterion, invoice complete-delivery verification scheme

3. Acceptance date criterion, specific unit verification scheme

4. Acceptance date criterion, invoice complete-delivery verification scheme.

With any form other than 1, i.e. the delivery date criterion, specific unit verification scheme, differences a rise between dealer sales and invoiced amounts. The invoice related data generating function 112 may be made so as to provide the dealer terminal with sales/invoice difference verification data for verifying those differences between invoiced amounts and sales amounts.

The invoice related data generating function 112 references the invoice payment condition master, references that predetermined closing day and the invoice criterion, whether the delivery to the customer or acceptance by the customer, and calculates the invoice amount from the dealer to the customer for one or a plurality of orders placed and received. Thus the preparation of invoices from the dealer to the customer is automated. The invoice related data generating function 112 may also be made so as to provide the customer terminal with acceptance condition data for verifying the condition of acceptance by the customer relative to delivered items.

When an invoice was received by a customer, conventionally, the statements of delivery were collected from the order placer belonging to the customer, and those were compared against that invoice. Meanwhile, when a payment notification was sent from the customer to the dealer, it was necessary for the dealer to verify the invoice and check against it. These business operations can be simplified by effecting checking through data processing. On the customer's end, however, enormous costs are entailed in inputting data on all items delivered, and, even assuming that the delivery data and invoice data can be generated, the information system must be integrated in order to match those data between a plurality of customers and a plurality of dealers, which is altogether too onerous and difficult to implement.

With this embodiment aspect, on the other hand, agreements between customer and dealer concerning invoicing are defined in the invoice payment condition master, and, for a given order, the data used for delivery, the data used for sales, and the data used for invoicing are the same data, wherefore, for both customer and dealer, the matching operations relating to delivery, sales, and invoicing can be simplified to merely verifying whether goods have been delivered or accepted. That is, the dealer, by only verifying that no goods have been left undelivered, can entrust the matching operation to the ASP system. And, by referencing the data relating to invoicing and the like generated by the invoice related data generating function 112 indicated in FIG. 16, current sales or invoiced amounts and the like can be obtained by the dealer terminal 1D. Furthermore, not only for sales (accounts receivable), but for laying in from wholesalers (accounts payable) also, merely by obtaining data from the server 10 relating thereto, detailed data on transaction particulars needed for accounting purposes for transactions for which the order placing and receiving system was used can be obtained. By linking this system with a server having settlement functions, moreover, automatic accounting system inputs can be made also for deposits and withdrawals of cash.

Based on the third embodiment aspect, as described in the foregoing, order receiving, delivery, and invoicing management and accounting for transactions with a customer with whom a periodic purchase agreement has been concluded can be automated. As a consequence, a dealer can sharply reduce his or her daily work load, and, for that reason, direct more business resources to improving customer services or proposing new product items and the like.

What is claimed is:

1. A system for placing orders for items, comprising a database having various masters, and a server for controlling data communications with a plurality of terminals via a network, and extracting or storing data to or from the various masters in response to requests from the terminals;
wherein the database comprises:
a merchandise master in which is registered information relating to items provided from a dealer to a customer, for each unique item number for the respective items; and
an MD related master in which is registered, as merchandise assortment (MD) related information, a list of traded items, whose trades have been agreed upon beforehand between that customer and dealer, among those items stored in that merchandise master, for each purchase unit of the customer and for each dealer providing the items to that customer; and
wherein the server comprises an item replacing controller for, when an item stored in the merchandise master is to be replaced with an item that is a replaceable item but is not contained in the MD related information, controlling the replacement of items provided to the dealers from the customers, according to an automatic replace level defined beforehand in the MD related information.

2. The system according to claim 1, wherein the item replacement controller comprises a price balance oriented determining function, and that function determines whether or not to automatically implement a replacement in the MD related information, according to the automatic replace level, and to price difference between price of new item and price of old item, that being price to customer from dealer.

3. The system according to claim 1, wherein the item replacement controller comprises a price form oriented determining function, and that function determines whether or not to automatically implement a replacement in the MD related information, according to difference of whether item price specifying form from the dealer to customer is a negotiated ratio for an item group or a negotiated price for an individual item, and to the automatic replace level.

4. The system according to claim 1, wherein the server comprises an item replacing unit for, when an order for an item for which a new item number has been defined in the MD related information by the item replacement controller is placed from a terminal used by a user belonging to the purchasing unit, making item replaced in that new item number object of order placement.

5. The system according to claim 1, wherein the item replacement controller comprises a deliverer specific out of production controlling function, and
wherein said function, when the old item has been taken out of production by the supplier, specifies a deliverer for delivering that item to be taken out of production to a customer, with reference to the MD related information; and
that item is logically deleted from the MD related information when that deliverer is not a dealer; and, when that deliverer is a dealer, prompts user of that dealer to reflect that out of production item in MD related information.

6. The system according to claim 1, wherein the item replacement controller comprises:
a new item storing function for, when an item replacement has been designated by the customer in response to a proposal to adopt a new product made to that customer, storing new item number designated by that customer in old MD data of MD related information used between that customer and the dealer; and
a new MD data storing function for storing new MD data for a new item number in the MD related information.

7. The system according to claim 6, wherein the item replacement controller comprises a duplication error output function, and that function outputs a duplication error, when the new item number is stored by the new item storing function in the MD related information, when dealers for same customer are redundant for that item number.

8. A system for placing orders for items, comprising a database having various masters, and a server for controlling data communications with a plurality of terminals via a network, and extracting or storing data to or from the various masters in response to requests from the terminals;
wherein the database comprises a merchandise master in which is registered information relating to items provided to a customer by item numbers unique to those items; and
wherein the server comprises an item replacement controller for, when an item stored in the merchandise master is to be replaced with a replaceable item, controls replacement of item provided to the customer according to automatic replace level defined beforehand for each of the customers.

9. A method for controlling item replacement using an order placing system, said order placing system comprising a database wherein are stored various masters, and a server for controlling data communications with a plurality of terminals via a network, and extracting or storing data to or from the various masters in response to requests from the terminals;
wherein the database comprises:
a merchandise master in which is registered information relating to items such as goods or services provided from a supplier through a retail outlet or other dealer to a customer, for each unique item number for those items; and
an MD related master in which is registered a list of traded items whose trades have been agreed upon beforehand between that customer and dealer, among those items stored in that merchandise master, as MD related information, for each purchase unit of the customer, for each dealer providing the items; and
the replacement control method comprises the steps of:
(a) specifying beforehand a replacement form, when an item among items provided from the dealer to a customer is to be replaced by a new item, as an automatic replace level, for each set of MD related information wherein unit thereof is made a list of those items handled;
(b) referencing a certain automatic replace level, when a proposal for adopting a new product or the like has been made to the customer by a sales activity entity such as a supplier or dealer or the like, namely the automatic replace level defined in MD related information for that customer;
(c) defining a form for determining price of old item, based on the MD related information, before or after step (b);
(d) calculating price difference between price of old item and price of new item, when price of that new item can be calculated, based on price determining form specified in step (c); and
(e) determining whether or not to implement item replacement, or whether or not a query is to be made to the dealer, according to combination of whether or not a price calculation was made in step (d), that price difference when such was calculated, and the automatic replace level.

10. The method according to claim 9, wherein the item replacement enable/disable step in (e) determines whether or not to implement item replacement based on price difference calculated in the price difference calculation step in (d) when the automatic replace level is level where most automatic determination is made.

11. The method according to claim 9, wherein the item replacement enable/disable step in (e) prompts negotiation between the customer and the dealer concerning whether or not to perform the item replacement according to the price difference calculated in the price difference calculation step in (d), when the automatic replace level is level where most automatic determination is made.

12. A Computer program product comprising a recording medium storing a program for controlling item replacement using an order placing system;
wherein the order placing system comprises a database which stores various masters, and a server for controlling data communications with a plurality of terminals via a network, and extracting or storing data to or from the various masters in response to requests from the terminals;
the database comprises:
a merchandise master in which is registered information relating to items provided from a dealer to a customer, for each unique item number for the items; and
an MD related master in which is registered a list of traded items whose trades have been agreed upon beforehand between that customer and dealer, among those items stored in that merchandise master, as MD related information for each purchase unit of the customer, and for each dealer providing the items to that customer; and
wherein the program for item replacement control causes the server to:
specify a replacement form, when an item among handled items provided from the dealer to a customer is to be replaced by a new item, as an automatic replace level, for each set of MD related information in which unit thereof is made a list of those items handled;
reference the automatic replace level defined in MD related information for that customer, when a proposal for adopting a new product or the like has been made to the customer by a sales activity entity for the customer such as supplier or dealer or the like;
reference MD related information and specify a form for determining price of old item;
calculate price difference between price of old item and price of new item, when price of that new item can be calculated, based on specified price determining form; and
determine whether or not to implement item replacement, or whether or not a query is to be made to the dealer, according to combination of whether or not a price calculation was made, that price difference when such was calculated, and the automatic replace level.

13. A system for placing orders for items, comprising a database wherein are stored various masters, and a server for controlling data communications with a plurality of terminals via a network, and extracting or storing data to or from the various masters in response to requests from the terminals;
wherein the database comprises:
a merchandise master in which is registered information relating to items provided from a dealer to a customer, for each unique item number for the items;
an MD related master which a list of traded items whose trades have been agreed upon beforehand between that customer and dealer, among those items stored in that merchandise master, as MD related information, for each purchase unit of the customer and for each dealer providing the items to that customer;
an item replacement master for managing the replacement of item numbers, item by item, proposed by a sales activity entity for the customer such as a supplier or dealer of items provided to the customer; and
an item replacement judgment master for managing condition of advance of item replacements stored in that item replacement master; and
wherein the server comprises:
an automatic replace level storage controller for storing an automatic replace level determined beforehand between that customer and dealer in the MD related information when the MD related information is stored in the MD related master;
an item specific item replacement storage controller which, when replacement of an item stored in the merchandise master is proposed by the sales activity entity, stores the old item number of that item replacement and a new item number that is a new item in the item replacement master;
a replacement object extraction controller which, after the old and new item numbers have been stored in the item replacement master, extracts the MD related information in which that old item number is assorted from the MD related information;
an MD specific item replacement determinator for determining whether or not to automatically implement an item replacement, for each set of MD related information, based on automatic replacement implementation level stored in the MD related information extracted by that replacement object extraction controller;
an automatic replacement controller which, when it has been determined by that MD specific item replacement determinator to perform an item replacement automatically, stores the new item number in the MD data specified by the old item number in plurality of sets of MD data in that MD related information; and
a replacement study controller which, when it has been determined by the MD specific item replacement determinator not to perform an automatic item replacement, prompts the dealer corresponding to that MD related information to store information relating to that item replacement.

14. The system according to claim 13, wherein automatic replace level defined in each of the sets of MD related information is one or other of a verification scheme level, intermediate scheme level, and automatic scheme level;
the verification scheme level is an automatic replace level that automatically performs replacement when there is no change in prices to the customer between old and new items, and prompts dealer managing that MD related information to input a price when price of the new item is higher or lower than the price of the old item;
the intermediate scheme level is an automatic replace level that, when there is a rate and an actual amount as schemes for determining prices to the customer, performs automatic replacement irrespective of the price difference between the old and new items when that determining scheme is a rate, but urges deal managing that MD related information to input a price when price of the new item is higher or lower than price of the old item; the automatic scheme level is an automatic replace level that determines whether or not to perform item replacement according to classifications determined beforehand according to price difference between old and new items, irrespective of scheme for determining price to the customer, without requiring the dealer to input a price; and
the MD specific item replacement controller comprises:
an automatic replace level specific determining function for determining whether or not to implement item replacement according to the automatic replace level scheme; and
a price input control function for prompting the dealer to store information relating to that item replacement when it has been determined by that automatic replace level determining function that storage and the like of a price by that dealer are necessary.

15. A system that places orders for items, comprising a database wherein are stored various masters, and a server for controlling data communications with a plurality of terminals via a network, and extracting or storing data to or from the various masters in response to requests from the terminals;
wherein the database comprises:
a merchandise master in which is registered information relating to items provided from a dealer to a customer, for each unique item number for the items; and
an MD related master in which is registered a list of traded items whose trades have been agreed upon beforehand between that customer and dealer, among those items stored in that merchandise master, as MD related information for each purchase unit of the customer and for each dealer providing the items to that customer; and
the server comprises:
a received order item replacing controller that, when an order placement request for ordering an item is received from a terminal used by a user belonging to the purchasing unit, references the MD related information, and, when a new item number is stored in that item, notifies user for receiving order for item of that new item number; and
an out of production item order changing controller for, when the MD related information is referenced and the item number for which the order placement request was received has gone out of production, prompting the user to change or cancel the order placed for that item.

16. Order placement data used in a system that controls order placing and receiving between a customer to whom a user using a terminal belongs and a dealer providing items such as goods or services to that customer, wherein
the order placing and receiving system comprises:
a database storing various masters; and
a server for controlling data communications with a plurality of terminals via a network, and extracting or storing data to or from the various masters in response to requests from the terminals;
the order placing and receiving system data are used by the order placing and receiving system for specifying a dealer handling an item ordered by a user; and
the order placement data comprise:
a data structure consisting of MD related master data;
a data structure consisting of MD unit master data; and
a data structure consisting of MD master data;
the MD related master data have:
an MD unit master wherein is stored an MD unit data group indicating an MD list defined for the dealer and each of the purchasing units of the customer; and
an MD master wherein is stored an MD data group wherein is stored information relating to distribution of items belonging to the MD unit in each of those MD units;
the MD master data have an automatic replace level for specifying a replacement form when performing a replacement of an item stored in the merchandise master in each of those MD units by an item that is a replaceable item and that is not contained in the MD related information; and
the MD related master data have new item number data in that item number belonging to that MD related information when item replacement has been performed for an item according to the automatic replace level.

17. A system for placing orders for items, comprising a database storing various masters; and a server that is connected via a network to a customer terminal for a customer and a dealer terminal for a dealer, for controlling data communications with those terminals, and extracting or storing data to or from the various masters in response to requests from the terminals;
wherein the database comprises:
a merchandise master in which is registered information relating to items supplied from a supplier through the dealer to a customer, for each unique item number for those items; and
an MD related master in which is registered a list of traded items whose trades have been agreed upon beforehand between that customer and dealer, among those items stored in that merchandise master, as MD related information, for each purchase unit of the customer and for each dealer providing the items to that customer; and
the server comprises:
a free form order controller which, when an order is placed from a particular customer terminal for an item not stored in MD related information oriented toward that customer of the one or plurality of dealers, controls an order placement or estimate request in a free form to a dealer group having MD related information oriented toward that customer; and
a dealer specifying controller for prompting the customer to specify a dealer to provide that customer with an item for which an order was placed or is scheduled to be placed by that free form order controller, from the plurality of dealer groups.

18. The system according to claim 17, wherein the server comprises a free-form communications controller for controlling communications between a dealer terminal specified by the dealer specifying controller and a customer terminal that places an order for an item by the free form order controller, and requests input of a data item roughly same as data item stored in the MD related information to the customer terminal or dealer terminal, in response to type of that data item, by those communications.

19. The system according to claim 18, wherein the free form communications controller comprises an expense item input control function for prompting input of expense item for the item for which that free form order placement was made to the customer terminal.

20. The system according to claim 17, wherein the database comprises purchasing unit specific free form order enable/disable data for specifying whether or not operation of the free form order controller is enabled for the customer or each purchasing unit of that customer.

21. The system according to claim 17, wherein the database comprises user specific free form order enable/disable data for specifying whether or not operation of the free form order controller is enabled for each user belonging to a purchasing unit of the customer.

22. The system according to claim 17, wherein the database comprises dealer specific free form order capable item group data for specifying item category or item group for which free form order placement is possible on dealer end.

23. The system according to claim 17, wherein the MD related information comprises a free form conforming order control flag for prompting a free form conforming order placement that conforms with free form for items that change individually for every order placement and receipt in terms of particulars and price of the item.

24. The system according to claim 17, wherein the server comprises a free form order content storage controller for, after order placement by the free form order controller has become definite, controls storing of particulars of that order in the MD related information.

25. A dealer application service provider system for providing order placement functions to terminals of one or a plurality of users belonging to a purchasing unit of a customer, and providing order receiving functions to terminals of a plurality of dealers providing items identified by item number to that customer, comprising a database which stores various masters such as a merchandise master in which is registered information relating to items that are goods or services; and a server, connected to terminals via a network such as Internet, for controlling sending and receiving of data with those terminals, and extracting or storing data from or to the various masters in response to requests at those terminals;
wherein the server comprises, as functions to be provided to a terminal used by the dealer:
an order receiving control function that, when an order has been placed for one or a plurality of items from the customer terminal, for each item, makes an item stored in MD related information for that customer of that dealer an order received by that dealer;
a delivery control function that controls arrangements for transferring one or plurality of items for which order was received by the order receiving control function, based on data stored beforehand in the MD related information;
a sales management control function for controlling accounting of sales by that dealer to that customer in response to the arrangements made by that delivery control function; and
a laying-in management control function for controlling accounting of dealer laying in related to those items, based on data stored beforehand in the MD related information.

26. The system according to claim 25, wherein the server further comprises, as a function to be provided to a terminal used by the dealer, an item replacement control function that, when replacements are made of items stored in the merchandise master by items that are replaceable items and that are contained in the MD related information, controls replacement of items provided from the dealer to the customers according to automatic replace level defined beforehand in the MD related information.

27. The system according to claim 25, wherein the server further comprises, as a function to be provided to a terminal used by the dealer, a free form order control function that, for items not stored in MD related information oriented toward the customer, receives order for an item ordered in free form from that customer terminal.

28. The system according to claim 25, wherein the database comprises an invoice payment condition master that, using an invoice recipient predetermined for a user belonging to a purchasing unit of a customer and an invoice originator predetermined by the dealer as keys, specifies the invoice payment conditions determined beforehand between that invoice recipient and invoice originator; and,
the server further comprises, as a function to be provided to a terminal used by the dealer, an invoice related data generating function that references the invoice payment conditions, references that predetermined closing day and invoice criteria such as delivery to customer or acceptance by customer, and generates data relating to invoices from dealer to customer for one or a plurality of orders placed and received.

29. A dealer application service provider system for providing order placement functions to terminals of one or a plurality of users belonging to a purchasing unit of a customer, and providing order receiving functions to terminals of a plurality of dealers providing items identified by item number to that customer, comprising a database which stores various masters such as a merchandise master in which is registered information relating to items that are goods or services; and a server, connected to terminals via a network such as Internet, for controlling sending and receiving of data with those terminals, and extracting or storing data from or to the various masters in response to requests at those terminals;
wherein the server comprises, as functions to be provided to a terminal used by the dealer:
an MD related information storing function that stores, for each purchasing unit to which a user of a customer belongs, a list of items provided to that purchasing unit, as MD related information, for each purchasing unit of that customer;
an order receiving control function that, when an order has been placed for one or a plurality of items from the customer terminal, for each item, makes an item stored in the MD related information for a purchasing unit of that customer of that dealer an order received by that dealer; and
an out of production effect retrieval function that, in cases where an item stored in the merchandise master has been taken out of production, retrieves the MD related information wherein that item is defined from the database.

30. The system according to claim 29, wherein the server further comprises, as a function to be provided to a terminal used by the dealer, an item replacement control function that reflects an item replacement that changes the item going out of production to another item in the MD related information of each purchasing unit of the customer.
